(19) United States
(12) Patent Application Publication
(10) Pub. No.: US 2015/0278983 A1
(43) Pub. Date: Oct. 1, 2015

(54) TERMINAL APPARATUS, ELECTRONIC WHITEBOARD SYSTEM, INPUT ASSIST METHOD FOR ELECTRONIC WHITEBOARD, AND MEDIUM

(71) Applicant: NEC Corporation, Tokyo (JP)

(72) Inventor: Yasuhisa UEFUJI, Tokyo (JP)

(73) Assignee: NEC Corporation

(21) Appl. No.: 14/666,428

(22) Filed: Mar. 24, 2015

(30) Foreign Application Priority Data
Apr. 1, 2014 (JP) 2014-075452

(51) Int. Cl. G06T 1/20; G09G 5/00; G06F 3/041; G06T 3/40

(52) U.S. Cl. CPC G06T 1/20; G06T 3/40; G09G 5/003; G06F 3/0416; G09G 2370/02

(57) ABSTRACT

An electronic whiteboard system that is capable of reducing the burden on a user in performing input operations on an electronic whiteboard, without restriction on input methods, are provided. An electronic whiteboard system (100) includes a server apparatus (20) that provides an electronic whiteboard on a network (30), and a terminal apparatus (10) for entering inputs. The terminal apparatus (10) includes setting a drawing area in which objects that include text and graphics are permitted to be drawn at an indicated place in an electronic whiteboard displayed in a screen, identifying content of an input operation performed on the electronic whiteboard, and estimating a command intended by the input operation, based on the content of the input operation and a relation between a location in the screen at which the input operation has been performed and a location of the drawing area.

This application is based upon and claims the benefit of priority from Japanese Patent Application No. 2014-075452, filed on April, 2014, the disclosure of which is incorporated herein in its entirety by reference.

### TECHNICAL FIELD

The present invention relates to an apparatus for utilizing an electronic whiteboard, an electronic whiteboard system, an input assist method for an electronic whiteboard system, and a medium that stores a program for the apparatus, the electronic whiteboard system, and the input assist method.

### BACKGROUND ART

In recent years, an electronic whiteboard that utilizes a network has been proposed in order to allow a plurality of users remote from each other to have a discussion via personal computers (PCs) and now via terminal apparatuses such as smart phones and tablets. Such an electronic whiteboard is a virtual whiteboard provided on a network, and each user can freely locate objects, such as text and graphics (arrows and the like), on a whiteboard displayed in a display screen of the user's own terminal apparatus. The electronic whiteboard allows two or more users to share and discuss information online as in the case where a real whiteboard is used.

By the way, the electronic whiteboard is required in terms of operability to allow a user to immediately write or draw what comes to the user's mind, in substantially the same manner as on the real whiteboard, no matter whether the user desires to write text or draw a graphic. However, in the foregoing electronic whiteboard, each user needs to select, in each event, an operation that the user wants to perform, for example, input of text, selection of an object, the drawing of a graphic, or the like, from a menu screen displayed separately on a tool bar or the like. Therefore, the foregoing electronic whiteboard has a problem of rendering it troublesome for a user to switch between writing text and drawing a graphic and thus not being designed to allow a user to immediately write what the user thinks.

Meanwhile, there have been proposed many technologies that assist in entering inputs in the operation of a typical terminal apparatus (see, e.g., Japanese Laid-open Patent Publication No. 2013-114593 (PTL 1) and Japanese Patent Publication No. 4301842 (PTL 2)). Therefore, it is considered that application of such technologies to the electronic whiteboard will solve the problem stated above.

Concretely, Japanese Laid-open Patent Publication No. 2013-114593 discloses a technology that is useful when it is necessary to frequently switch between handwriting with a pen device and menu operation with a mouse. The technology disclosed in this laid-open patent publication determines which one of handwriting with a pen device or a mouse event is occurring on the basis of a result of determination as to whether the pen device is on or off and a result of determination as to whether the location of the pen device is within a drawing region.

Japanese Patent Publication No. 4301842 discloses a technology that automatically determines a selection mode for selecting an object to operate on, on the basis of input via a mouse or a stylus. The technology disclosed in Japanese Patent Publication No. 4301842 automatically selects an optimum selection mode from a plurality of selection modes on the basis of the starting location of a selecting gesture, the path of a drag, and the like, without requiring a selecting operation from a menu. Incidentally, the selection modes include a selection mode based on clicking or tapping, a selection mode based on a rectangular drag area, a selection mode based on free-shape path, and a selection mode based on polygon enclosure.

Furthermore, exclusively when a user's terminal apparatus is a PC, operation can be switched by right-clicking the mouse or entering a shortcut key from the keyboard, without a need to perform selection from the tool bar.

PTL 1: Japanese Laid-open Patent Publication No. 2013-114593

PTL 2: Japanese Patent Publication No. 4301842

### SUMMARY

An example of an object of the present invention is to provide a terminal apparatus, an electronic whiteboard system, an input assist method for an electronic whiteboard, and a medium that stores a program for the terminal apparatus, the electronic whiteboard system, and the input assist method which are capable of reducing the burden on a user in performing input operations on an electronic whiteboard, without restriction on input methods.

In order to achieve the foregoing object, a terminal apparatus according to an aspect of the present invention includes: an object display unit that sets, at an indicated place in an electronic whiteboard displayed in a screen, a drawing area in which objects that include text and graphics are permitted to be drawn; an input operation identification unit that identifies content of an input operation performed on the electronic whiteboard; and an input operation estimation unit that estimates a command intended by the input operation, based on identified content of the input operation and a relation between a location in the screen at which the input operation has been performed and a location of the drawing area.

In order to achieve the foregoing object, an electronic whiteboard system according to another aspect of the present invention includes: a server apparatus that provides an electronic whiteboard on a network; and a terminal apparatus for entering an input to the electronic whiteboard, wherein the terminal apparatus includes: an object display unit that sets, at an indicated place in the electronic whiteboard displayed in a screen, a drawing area in which objects that include text and graphics are permitted to be drawn; an input operation identification unit that identifies content of an input operation performed on the electronic whiteboard; and an input operation estimation unit that estimates a command intended by the input operation, based on identified content of the input operation and a relation between a location in the screen at which the input operation has been performed and a location of the drawing area.

Furthermore, in order to achieve the foregoing object, an input assist method for an electronic whiteboard according to still another aspect of the present invention is a method in which a computer sets, at an indicated place in the electronic whiteboard displayed in a screen, a drawing area in which objects that include text and graphics are permitted to be drawn, identifies content of an input operation performed on the electronic whiteboard, and estimates a command intended by the input operation, based on identified content of the input operation and a relation between a location in the screen at which the input operation has been performed and a location of the drawing area.

Still further, in order to achieve the foregoing object, a non-transitory computer-readable recording medium according to a further aspect of the present invention stores a program that causes a computer to set, at an indicated place in the electronic whiteboard displayed in a screen, a drawing area in which objects that include text and graphics are permitted to be drawn, identify content of an input operation performed on the electronic whiteboard, and estimate a command intended by the input operation, based on identified content of the input operation and a relation between a location in the screen at which the input operation has been performed and a location of the drawing area.

### BRIEF DESCRIPTION OF THE DRAWINGS

Exemplary features and advantages of the present invention will become apparent from the following detailed description when taken with the accompanying drawings in which:

FIG. 1 is a diagram illustrating a general configuration of an electronic whiteboard system in an exemplary embodiment of the present invention;

FIG. 2 is a block diagram illustrating configurations of a terminal apparatus and a server apparatus in the exemplary embodiment;

FIG. 3 is a diagram presenting an example of data stored in a data storage unit of the terminal apparatus in the exemplary embodiment;

FIG. 4 is a diagram presenting an example of data stored in a management data storage unit of the server apparatus in the exemplary embodiment;

FIG. 5 is a diagram presenting an example of data stored in a whiteboard storage unit of the server apparatus in the exemplary embodiment;

FIG. 6 is a flowchart illustrating an operation performed during an input operation estimation phase of the terminal apparatus in the exemplary embodiment;

FIG. 7 is a flowchart specifically illustrating an estimation process 1 illustrated in FIG. 6;

FIG. 8 is a diagram illustrating a specific example of a process performed when an input operation has been performed in a drawing area;

FIG. 9 is a diagram for describing activation and deactivation of a drawing area;

FIG. 10 is a flowchart specifically illustrating an estimation process 2 illustrated in FIG. 6;

FIG. 11 is a diagram illustrating a specific example of a process performed when a drag operation has been performed in a drawing area;

FIG. 12 is a flowchart specifically illustrating an estimation process 3 illustrated in FIG. 6;

FIG. 13 is a flowchart illustrating an operation performed during an object registration/sharing phase of the terminal apparatus in the exemplary embodiment;

FIG. 14 is a diagram illustrating an expansion-or-reduction operation process for a drawing area for edit illustrated in FIG. 13;

FIG. 15 is a flowchart illustrating an operation of the server apparatus in the exemplary embodiment and illustrating a case where a user has performed an operation on a drawing area;

FIG. 16 is a flowchart illustrating an operation of the server apparatus in the exemplary embodiment and illustrating a case where a user has performed an operation on an object in a drawing area;

FIG. 17 is a diagram illustrating Modification 4 of the exemplary embodiment;

FIG. 18 is a diagram illustrating Modification 5 of the exemplary embodiment;

FIG. 19 is a diagram illustrating Modification 6 of the exemplary embodiment;

FIG. 20 is a diagram illustrating Modification 9 of the exemplary embodiment;

FIG. 21 is a diagram illustrating Modification 12 of the exemplary embodiment;

FIG. 22 is a diagram illustrating Modification 13 of the exemplary embodiment;

FIG. 23 is a diagram illustrating Modification 14 of the exemplary embodiment;

FIG. 24 is a diagram illustrating Modification 15 of the exemplary embodiment;

FIG. 25 is a diagram illustrating Modification 16 of the exemplary embodiment; and

FIG. 26 is a block diagram illustrating an example of a computer that realizes the terminal apparatus in the exemplary embodiment.

### EXEMPLARY EMBODIMENT

### Exemplary Embodiments

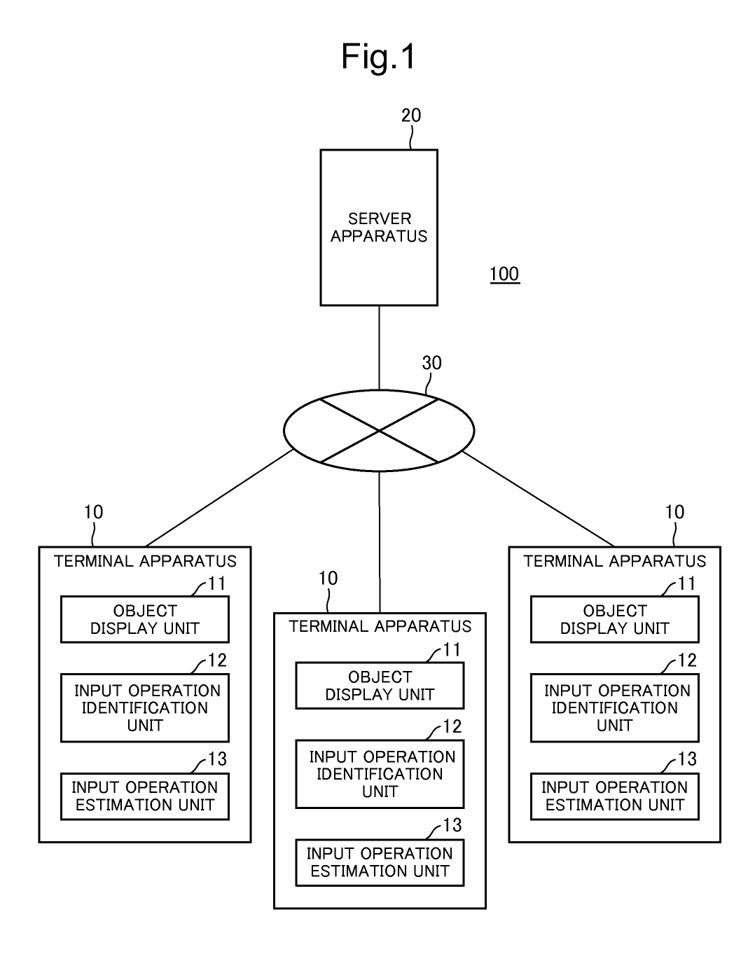

Hereinafter, a terminal apparatus, an electronic whiteboard system, an input assist method for an electronic whiteboard, and a medium that stores a program for the terminal apparatus, the electronic whiteboard system, and the input assist method according to exemplary embodiments of the present invention will be described with reference to FIG. 1 to FIG. 26.

### System Configuration and Apparatus Configuration

First, a general configuration of an electronic whiteboard system in an exemplary embodiment will be described with reference to FIG. 1. FIG. 1 is a diagram illustrating a general configuration of the electronic whiteboard system in an exemplary embodiment of the present invention.

As illustrated in FIG. 1, an electronic whiteboard system 100 in this exemplary embodiment includes a server apparatus 20 and a terminal apparatus 10. Of these apparatuses, the server apparatus 20 functions as a whiteboard providing apparatus that provides an electronic whiteboard on a network. In the description below, the server apparatus 20 may also be termed the “electronic whiteboard providing apparatus” 20.

The terminal apparatus 10 is an apparatus for entering inputs into an electronic whiteboard, and includes an object display unit 11, an input operation identification unit 12, and an input operation estimation unit 13. Of these units, the object display unit 11 sets a drawing area in which objects, including text and graphics, are permitted to be drawn, at a location that is indicated in an electronic whiteboard displayed on a display screen. When an input operation is performed on the electronic whiteboard, the input operation identification unit 12 identifies the content of the input operation.

The input operation estimation unit 13 estimates a command intended by the input operation on the basis of the identified content of the input operation and a relation between the location in the screen at which the input operation has been performed and the location of the drawing area. Specifically, the input operation estimation unit 13 estimates the input operation is which one of input of text, selection of an object, or the drawing of a graphic.

Thus, in this exemplary embodiment, when a user operates the electronic whiteboard, the terminal apparatus 10 estimates the command that the user's input operation intends. Furthermore, the estimation is performed without limiting input methods. Therefore, according to this exemplary embodiment, the burden on a user in performing input operation at the time of using an electronic whiteboard can be reduced without any restriction on input methods. The terminal apparatus 10 described above is an example of an embodiment of a minimum configuration of the present invention.

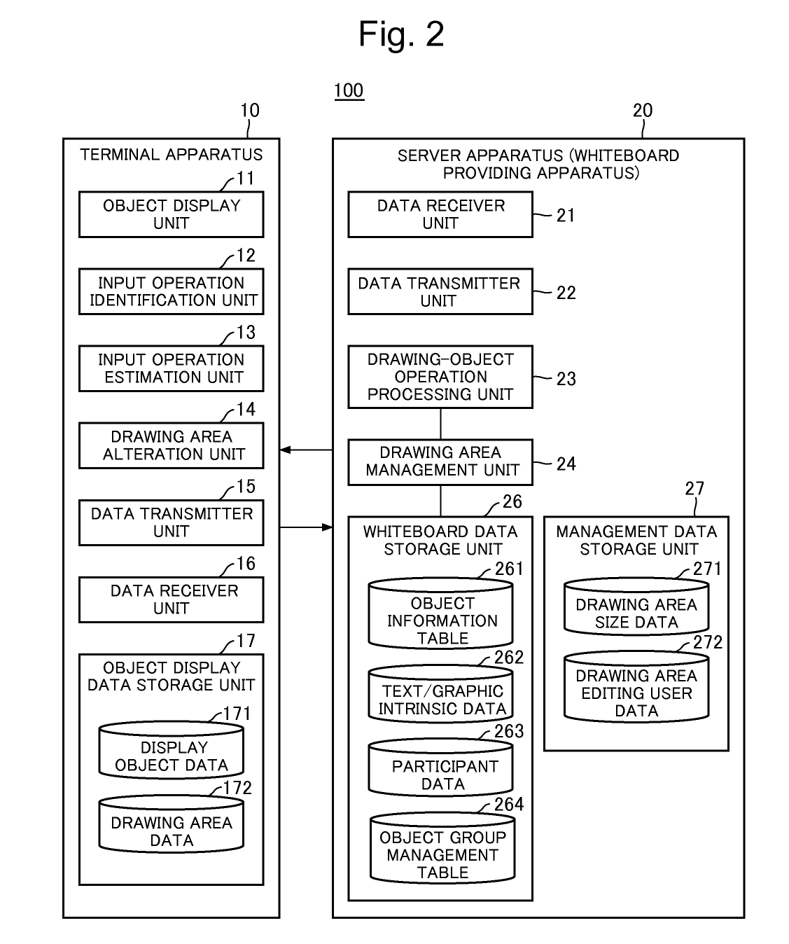

Subsequently, with reference to FIG. 2, configurations of a terminal apparatus and a server apparatus that constitute an electronic whiteboard system will be further specifically described. FIG. 2 is a block diagram illustrating configurations of a terminal apparatus and a server apparatus in an exemplary embodiment of the present invention.

### Terminal Apparatus

First, the terminal apparatus 10 will be described. In this exemplary embodiment, specific examples of the terminal apparatus 10 include portable information terminals, such as a smart phone and a tablet terminal, personal computers (PCs), and the like. The terminal apparatus 10 is configured by installing a program described below into such an appliance. Although in the example presented in FIG. 2, only one terminal apparatus 10 is depicted for the sake of simple illustration, the number of terminal apparatuses 10 is not particularly limited in this exemplary embodiment.

As illustrated in FIG. 2, the terminal apparatus 10 includes the object display unit 11, the input operation identification unit 12, and the input operation estimation unit 13 as mentioned above, and further includes a drawing area alteration unit 14, a data transmitter unit 15, a data receiver unit 16, and a data storage unit 17. The data storage unit 17 stores display object data 171, and drawing area data 172. Specific examples of these kinds of data will be described later.

The object display unit 11 first acquires the display object data 171 stored in the data storage unit 17 and, in accordance with the acquired data, displays objects, such as text and graphics in the electronic whiteboard displayed in the screen (not illustrated in FIG. 2).

Furthermore, the object display unit 11 acquires the drawing area data 172 stored in the data storage unit 17 and, in accordance with the acquired data, sets a drawing area mentioned above and displays the drawing area in the electronic whiteboard. When the display object data 171 and the drawing area data 172 are updated, the object display unit 11 updates the electronic whiteboard in the screen on the basis of the updated data.

The input operation identification unit 12 identifies the content of an input operation that a user performs by operating an input device (not illustrated in FIG. 2) provided for the terminal apparatus 10, for example, a keyboard, a mouse, a touch panel, or the like. Specific examples of the content of an input operation include character input, clicking/tapping, dragging, and the like.

Since clicking and tapping are basically the same operation while differing merely in the device used, the input operation identification unit 12 identifies clicking and tapping as the same input operation. Furthermore, when identifying the content of an input operation, the input operation identification unit 12 is also able to identify which one of designation of one point in the screen, designation of two or more points in the screen, or input of text into the screen has been performed as the input operation.

The input operation estimation unit 13 estimates whether which one of the input of text, the selection of an object, or the drawing of a graphic corresponds to the input operation, on the basis of the content of the input operation and a relation between the location in the screen at which the input operation has been performed and the location of the drawing area as described above.

Furthermore, the input operation estimation unit 13 determines whether the user is participating in the drawing area on the basis of the input operation performed by the user and, on the basis of a result of the determination, executes the switching between the participation in the drawing area and the end of the participation. After that, the data transmitter unit 15 sends information that indicates the participation or the end of the participation, to the server apparatus 20.

The data transmitter unit 15 sends information that identifies the input operation estimated by the input operation estimation unit 13, information that identifies the input operation actually performed, information that indicates participation or end of the participation, and the like as operation information to the server apparatus (whiteboard providing apparatus) 20. Furthermore, when an input operation has caused a change in the drawing area, the data transmitter unit 15 sends information that identifies the change to the server apparatus 20. Therefore, the server apparatus 20 updates the information displayed in the electronic whiteboard, on the basis of the information sent to the server apparatus 20.

The drawing area alteration unit 14 enlarges or reduces the size of the drawing area according to an instruction from the server apparatus 20. Furthermore, the drawing area alteration unit 14 causes the object display unit 11 to display in the screen a drawing area that has been enlarged or reduced in size.

The data receiver unit 16 receives information sent from the server apparatus 20, for example, a result caused by the input operation that the user of the terminal apparatus 10 has performed and a result of an input operation that another user has performed on a different terminal apparatus. Furthermore, using the results received, the data receiver unit 16 causes the object display unit 11 to update the electronic whiteboard. Specifically, the data receiver unit 16, using the results received, updates the display object data 171 and the drawing area data 172, and causes the object display unit 11 to reflect the content of the update in the screen. Furthermore, at that time, too, the drawing area alteration unit 14 enlarges or reduces the drawing area as described above.

Furthermore, when another user with a different terminal apparatus participates or ends the participation in the drawing area, the server apparatus 20 sends information that indicates this, so that the data receiver unit 16 also receives this information as well. In this case, too, the data receiver unit 16 updates the display object data 171 and the drawing area data 172 and causes the object display unit 11 to reflect the content of the update in the screen.

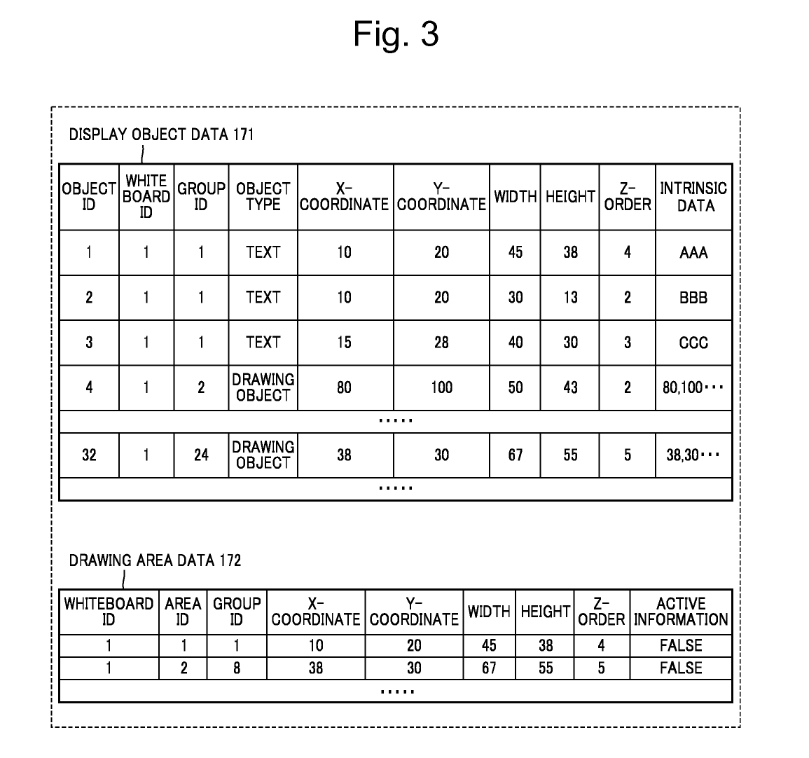

With reference to FIG. 3, specific examples of the display object data 171 and the drawing area data 172 stored in the data storage unit 17 will be described. FIG. 3 is a diagram illustrating examples of data stored in a data storage unit of a terminal apparatus in an exemplary embodiment of the present invention.

As indicated in FIG. 3, the display object data 171 includes information needed to display text on the whiteboard and information needed to display graphics on the whiteboard. Specifically, the display object data includes the object ID (IDENTIFIER), the whiteboard ID, the group ID, the object type, the x-coordinate, the y-coordinate, the width, the height, the z-order, and the intrinsic data of each object. The z-order of an object is a value that represents the location of the object in a front-rear direction when the object is displayed.

Of these pieces of data, the whiteboard ID of an object is the ID of the whiteboard where the object is displayed, and the group ID of an object is the ID of the group to which the object belongs. Furthermore, in this exemplary embodiment, each object belongs to a group, and each drawing area is associated with a group. That is, objects present in the same drawing area constitute a group.

Furthermore, as illustrated in FIG. 3, the drawing area data 172 includes information that identifies the drawing area that presently exists on the whiteboard, and information (active information) that identifies the drawing area in which editing users that include the user of the terminal apparatus 10 exist. Specifically, the drawing area data 172 includes the whiteboard ID, the area ID, the group ID, the x-coordinate, the y-coordinate, the width, the height, the z-order, and active information of each drawing area.

The active information is information that is unique to the drawing area data 172 and that indicates whether a user is presently performing a drawing operation in a drawing area concerned. As for the active information, all the initial values are set inactive (FALSE). Furthermore, on the basis of the drawing area data 172, the object display unit 11 displays only a drawing area registered in the drawing area data 172 and, at that time, discriminates active drawing areas and inactive drawing areas.

In this exemplary embodiment, unlike the objects, a drawing area is deleted from the electronic whiteboard if none of users, including the user of the terminal apparatus 10, is editing in the drawing area as described below. At the same time, the corresponding data is erased from the drawing area data 172. It is not the case that there always exists a drawing area.

### Server Apparatus (Whiteboard Providing Apparatus)

Subsequently, a configuration of the server apparatus 20 will be described. As illustrated in FIG. 2, the server apparatus 20 includes a data receiver unit 21, a data transmitter unit 22, a drawing-object operation processing unit 23, a drawing area management unit 24, a whiteboard data storage unit 26, and a management data storage unit 27.

Of these units, the whiteboard data storage unit 26 stores an object information table 261, text/graphic intrinsic data 262, participant data 263, and an object group management table 264. The management data storage unit 27 stores drawing area size data 271 and drawing area-editing user data 272. Specific examples of the data stored in the whiteboard data storage unit 26 and the management data storage unit 27 will be described later.

The data receiver unit 21 receives operation information sent from a terminal apparatus 10, and passes the information to the drawing-object operation processing unit 23. The drawing-object operation processing unit 23 identifies from the operation information the input operation performed on the object in the terminal apparatus 10 and, on the basis of the identified input operation, updates various data stored in the whiteboard data storage unit 26.

Furthermore, the drawing-object operation processing unit 23 groups objects that are present in the same drawing area at the time of update. Then, the drawing-object operation processing unit 23 manages information about the objects and information about the groups by using the object information table 261 and the object group management table 264, respectively.

The drawing area management unit 24 manages information that identifies a drawing area set by a terminal apparatus 10, information that identifies an object drawn in the drawing area, and information that identifies the user of the terminal apparatus 10 who is performing an input operation in the drawing area.

Specifically, when data is updated in the whiteboard data storage unit 26, the drawing area management unit 24 corrects, on the basis of the updated data, the range of the drawing area and identifies the users (editing users) that are participating in the drawing area. Then, using results of these processes, the drawing area management unit 24 updates the data stored in the management data storage unit 27.

Furthermore, each terminal apparatus 10 sends information that identifies the drawing area that is newly set, to the server apparatus 20, or sends information that identifies the changing of objects in the drawing area that has already been set, to the server apparatus 20. In this case, the drawing area management unit 24 instructs the terminal apparatus 10 that has sent the information to the server apparatus 20 to enlarge the newly set drawing area or the drawing area where the changing of objects has occurred.

Furthermore, after data is updated in the whiteboard data storage unit 26 and the management data storage unit 27, the data transmitter unit 22 sends the updated data to the terminal apparatus 10 of each user who is participating in the electronic whiteboard.

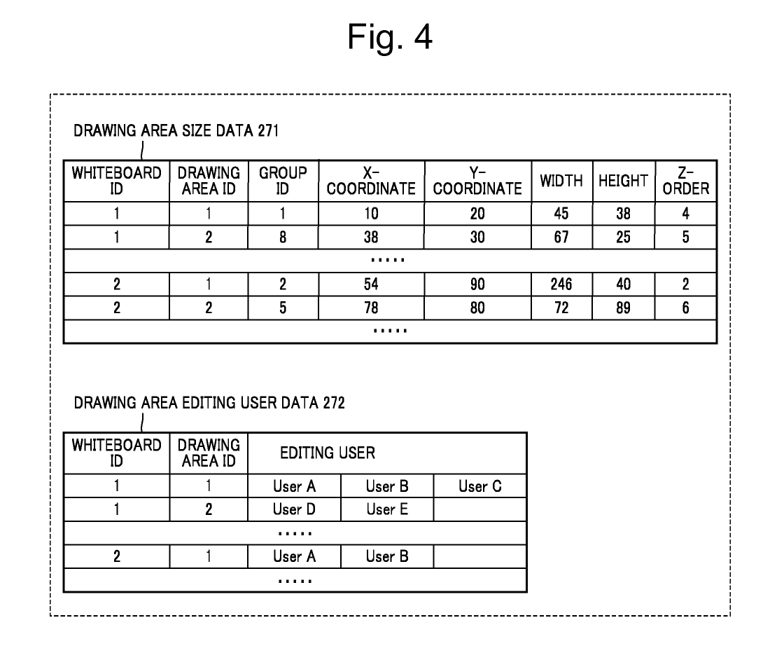

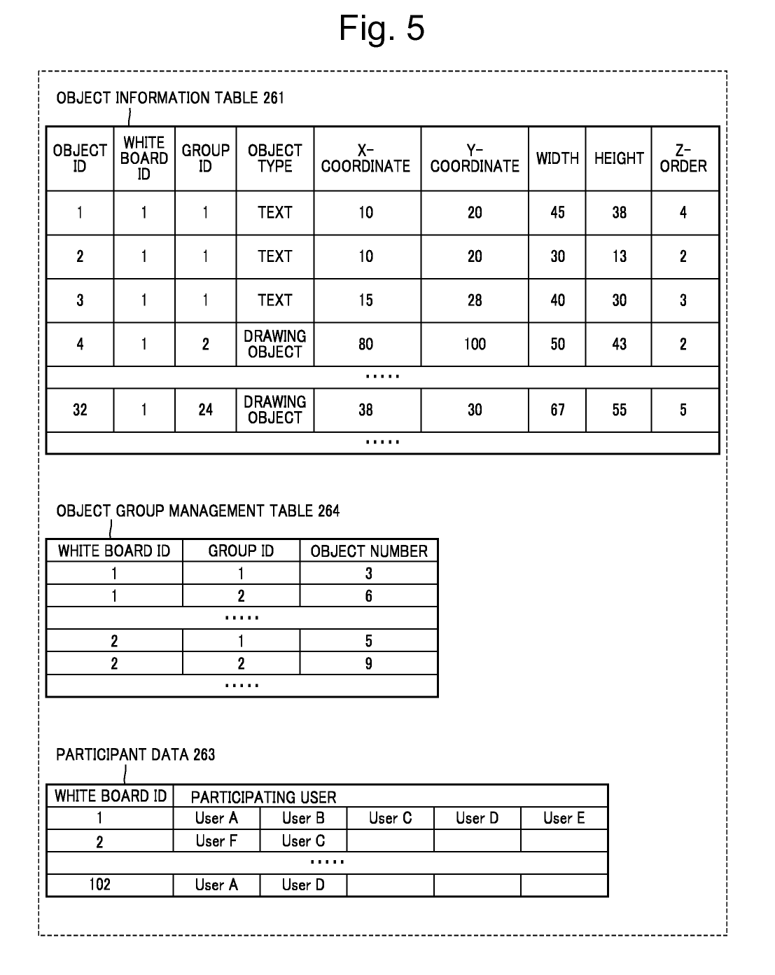

With reference to FIG. 4 and FIG. 5, specific examples of the data stored in the whiteboard data storage unit 26 and the management data storage unit 27 will be described. FIG. 4 is a diagram presenting an example of data stored in the management data storage unit of a server apparatus in an exemplary embodiment of the present invention. FIG. 5 is a diagram presenting an example of data stored in the whiteboard storage unit of a server apparatus in an exemplary embodiment of the present invention.

As indicated in FIG. 4, the drawing area size data 271 includes the whiteboard ID, the drawing area ID, the x-coordinate, the y-coordinate, the width, the height, and the z-order, regarding each drawing area. The drawing area-editing user data 272 includes the whiteboard ID, the drawing area ID, and the identifier of an editing user, regarding each drawing area. Since drawing areas are dynamically created, the drawing area IDs in the drawing area size data 271 and the drawing area-editing user data 272 are numbered sequentially from 1 separately for each whiteboard, each drawing area ID being numbered when created.

Furthermore, as indicated in FIG. 5, the object information table 261 includes the object ID, the whiteboard ID, the group ID, the object type, the x-coordinate, the y-coordinate, the width, the height, and the z-order, regarding each object. Thus, the objects are separated according to the types, that is, text or graphics (drawing objects), and therefore each object belongs to a group.

The object group management table 264 includes the whiteboard ID, the group ID, and the object number, regarding each object group. The object number represents the number of objects that belong to each object group. Thus, in this exemplary embodiment, since the objects present in a drawing area are grouped as described above, objects created by two or more users can also be handled as one group.

The participant data 263 includes the whiteboard ID and the identifiers of participating users, regarding each whiteboard. According to the participant data 263, the users participating in each whiteboard are identified.

### System Operation And Apparatus Operation

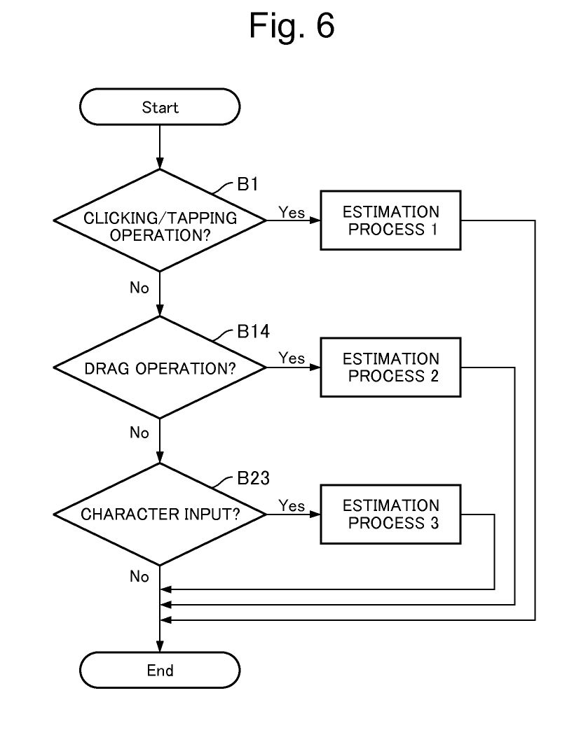

Next, operations of an electronic whiteboard system in an exemplary embodiment of the present invention will be described with reference to FIG. 6 to FIG. 15. In this exemplary embodiment, an input assist method for an electronic whiteboard is carried out by operating terminal apparatuses that constitute the electronic whiteboard system. Therefore, description of the input assist method for an electronic whiteboard in this exemplary embodiment will be substituted with description of operations of the electronic whiteboard system below.

### Operations of Terminal Apparatus

In this exemplary embodiment, each terminal apparatus 10 performs two roughly divided operations that are operations performed during an input operation estimation phase and during an object registration/sharing phase. During the input operation estimation phase, when a user has performed an input operation, it is estimated which one of input of text, selection of an object, or the drawing of a graphic is the command intended by the input operation. During the object registration/sharing phase, the estimated command is registered in the server apparatus 20, and the post-command updated data is shared among the terminal apparatuses 10. Furthermore, during the object registration/sharing phase, size enlargement of drawing areas is automatically performed. Hereinafter, the operations will be individually described.

Input Operation Estimation Phase:

The input operation estimation phase will be described with reference to FIG. 6 to FIG. 12. Firstly, an overall description of the drawing operation estimation phase will be given with reference to FIG. 6.

It is assumed beforehand that a user has activated an application program for utilizing an electronic whiteboard on a terminal apparatus 10. Due to this, information about the electronic whiteboard, for example, information that identifies a list of objects (text/graphics) and information that identifies the drawing areas that presently exist in the electronic whiteboard, is sent from the server apparatus 20 to the terminal apparatus 10. Furthermore, these pieces of information are stored in the data storage unit 17 as display object data 171 and drawing area data 172. The object display unit 11 displays a whiteboard in the display screen on the basis of the information received.

As illustrated in FIG. 6, when the user performs an input operation, the input operation identification unit 12 first determines whether the input operation is either one of clicking or tapping (step B1). If it is determined in step B1 that the input operation is clicking or tapping, an estimation process 1 by the input operation estimation unit 13 is performed.

On the other hand, if it is determined in step B1 that the input operation is neither clicking nor tapping, the input operation identification unit 12 determines whether the input operation is a drag operation (step B14). If in step B14 it is determined that the input operation is a drag operation, an estimation process 2 by the input operation estimation unit 13 is performed.

Still further, if in step B14 it is determined that the input operation is not even a drag operation, the input operation identification unit 12 determines whether the input operation is character input (step B23). If in step B23 it is determined that the input operation is character input, an estimation process 3 by the input operation estimation unit 13 is performed.

The input operation estimation unit 13 estimates the command intended by the input operation (a drawing operation by the user) using as arguments the result of the determination regarding the input operation and the information about the location at which the input operation has been performed. The estimation processes 1 to 3 by the input operation estimation unit 13 will be described. In this exemplary embodiment, since it is expected that a plurality of users will simultaneously use the electronic whiteboard, the following description includes a description of an estimating operation performed when a drawing area is displayed in a display screen.

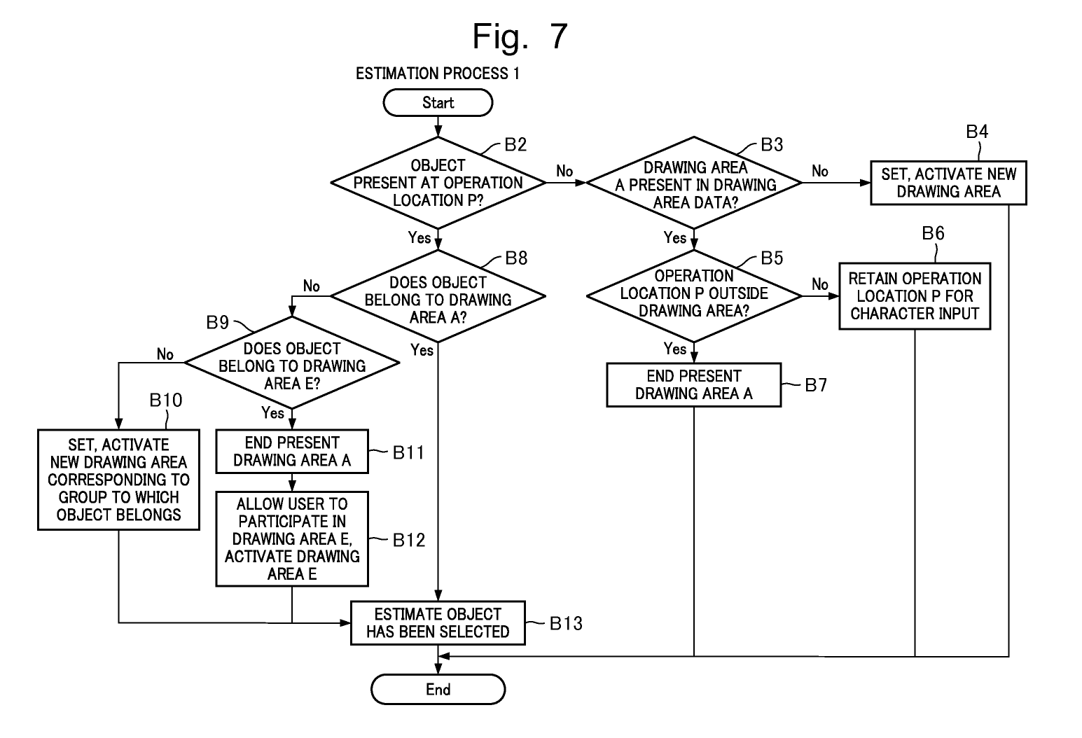

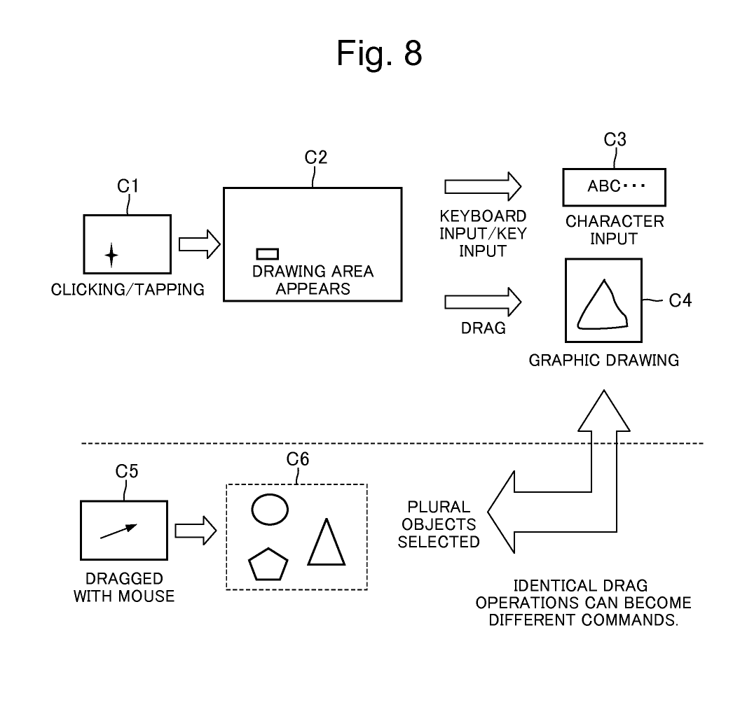

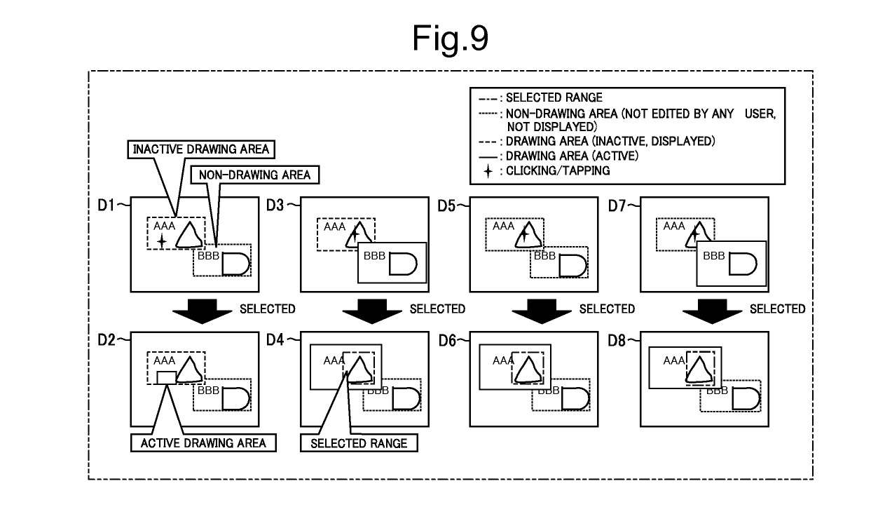

First, the estimation process 1 will be described. FIG. 7 is a flowchart specifically illustrating the estimation process 1 illustrated in FIG. 6. FIG. 8 is a diagram illustrating a specific example of the process performed when an input operation has been performed in a drawing area. FIG. 9 is a diagram for describing the activation and deactivation of a drawing area. In FIG. 7 and FIG. 9, “drawing area A” indicates an active (activated) drawing area. Furthermore, “drawing area E” indicates an inactive (deactivated) drawing area present in the drawing area data 172. Still further, “operation location P” indicates the operation location of clicking or tapping.

As illustrated in FIG. 7, when it is determined in step B1 mentioned above that the input operation is clicking or tapping, the input operation estimation unit 13 determines whether an object is present at the operation location (step B2). If in step B2 it is determined that no object is present at the operation location, the input operation estimation unit 13 further determines whether an activated drawing area is present in the drawing area data 172 (step B3).

If in step B3 it is determined that no activated drawing area is present, the input operation estimation unit 13 sets and activates a new drawing area at the aforementioned operation location (step B4), and ends the process.

In short, if a place without an object is selected while there is no active drawing area, a new drawing area is created at the location of the selection regardless of whether the location is inside or outside an existing drawing area or an existing non-drawing area (see C1 and C2 in FIGS. 8 and D1 and D2 in FIG. 9).

On the other hand, if in step B3 it is determined that an activated drawing area is present, the input operation estimation unit 13 determines whether the operation location is outside the activated drawing area (step B5).

If in step B5 it is determined that the operation location is not outside the drawing area, the input operation estimation unit 13 retains the aforementioned operation location (step B6) in preparation for an character input operation, and ends the process. On the other hand, if in step B5 it is determined that the operation location is outside the drawing area, the input operation estimation unit 13 ends the presently activated drawing area (step B7), and then ends the process. In other words, the active drawing area is ended by the user clicking or tapping outside the area (steps B5 and B7 in FIG. 7).

If in step B2 mentioned above it is determined that an object is present at the operation location, the input operation estimation unit 13 determines whether the object belongs to the activated drawing area (step B8).

If in step B8 it is determined that the object belongs to the activated drawing area, the input operation estimation unit 13 estimates that the object has been selected (step B13). On the other hand, if in step B8 it is determined that the object does not belong to the activated drawing area, the input operation estimation unit 13 determines whether the object belongs to a deactivated drawing area (step B9).

If in step B9 it is determined that the object belongs to a deactivated drawing area, the input operation estimation unit 13 ends the presently activated drawing area (step B11). Subsequently, the input operation estimation unit 13 allows the user to participate in this deactivated drawing area and activates the drawing area (step B12), and then executes step B13.

In short, if an object in a drawing area or a non-drawing area is selected regardless of the presence/absence of a presently active drawing area, the drawing area of the group to which the selected object belongs is activated (see D3 to D8 in FIG. 9). Furthermore, if data about the drawing area exists in the drawing area data 172, the server apparatus 20 is notified that the user will participate in the drawing area (see D3 and D4 in FIG. 9).

On the other hand, if in step B9 it is determined that the object does not belong to a deactivated drawing area, the input operation estimation unit 13 sets and activates a new drawing area that corresponds to the group to which the object belongs (step B10). After that, the input operation estimation unit 13 executes step B13.

In short, when an object is present in a place where no drawing area is present (non-drawing area), that is, when no data exists in the drawing area data 172, the group ID of the selected object is acquired from the display object data 171. Then, the server apparatus 20 is notified that that group will be drawn in a new drawing area, that is, the user will participate in a new drawing area.

Due to this, the server apparatus 20 calculates the size of the drawing area of the group, and returns information that identifies the drawing area as described below. Furthermore, when the returned information is added to the drawing area data 172, the new drawing area is turned active (see D5 to D8 in FIG. 9). In the activated new drawing area, the display-related z-order of each object that belongs to the drawing area is rewritten. Then, these objects are always displayed at the forefront.

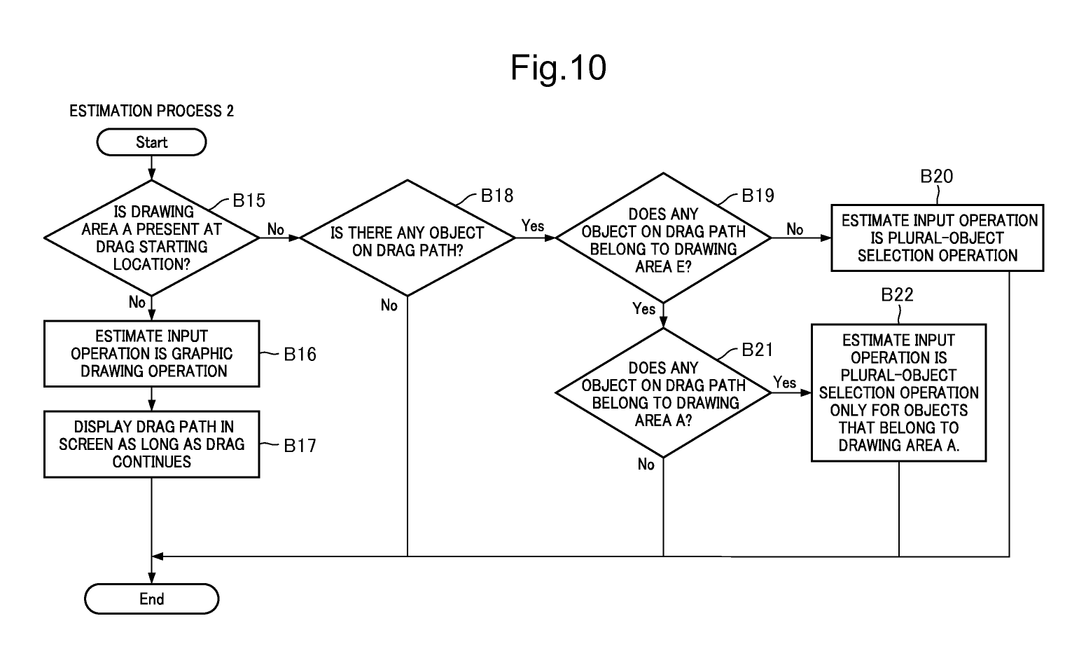

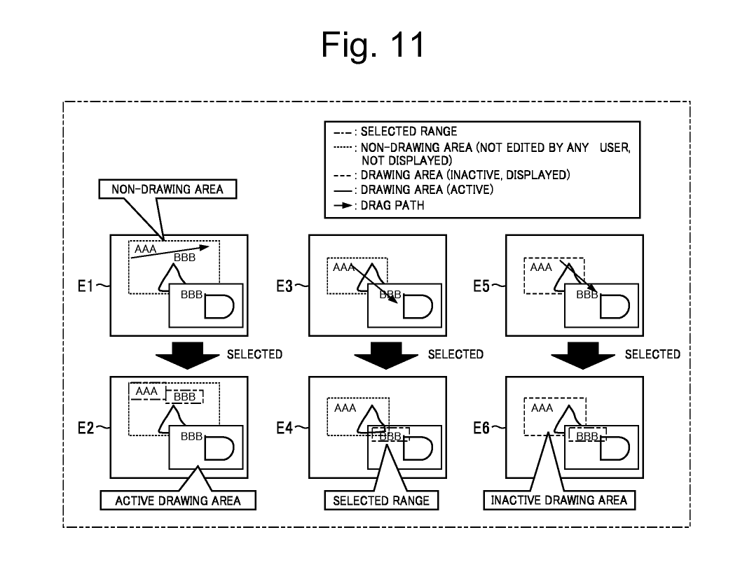

Subsequently, the estimation process 2 will be described. FIG. 10 is a flowchart specifically illustrating the estimation process 2 illustrated in FIG. 6. FIG. 11 is a diagram illustrating a specific example of a process performed when a drag operation is performed in a drawing area.

As illustrated in FIG. 10, when in step B14 mentioned above it is determined that the input operation is a drag operation, the input operation estimation unit 13 determines whether an activated drawing area is present at the drag starting location (step B15).

If in step B15 it is determined that an activated drawing area is present at the drag starting location, the input operation estimation unit 13 estimates that a graphic drawing operation has been performed (step B16). Subsequently, the input operation estimation unit 13 causes the object display unit 11 to display the path of the drag operation in the screen as long as the drag operation continues (step B17).

In short, if a drag operation is performed in a drawing area while an active drawing area is displayed, the input operation is estimated to be a drawing operation (see C4 in FIG. 8). Furthermore, if the starting location is within an active drawing area, the input operation is estimated to be a graphic drawing. On the other hand, if a drag operation is performed outside an active drawing area, it is estimated that the input operation is a plural-object selection operation as described below (see C5 and C6 in FIG. 8).

On the other hand, if in step B15 it is determined that an activated drawing area is not present at the drag starting location, the input operation estimation unit 13 determines whether there is any object on the drag path (step B18).

If in step B18 it is determined that the drag path is free from any object, the input operation estimation unit 13 ends the process. On the other hand, if in step B18 it is determined that there is one or more objects on the drag path, the input operation estimation unit 13 determines whether any of the one or more objects on the drag path belongs to a deactivated drawing area (step B19).

If in step B19 it is determined that none of the one or more objects on the drag path belongs to any deactivated drawing area, the input operation estimation unit 13 estimates that the input operation is a selection operation for a plurality of objects (step B20).

On the other hand, if in step B19 it is determined that, of the one or more objects on the drag path, one or more objects belong to a deactivated drawing area, the input operation estimation unit 13 determines whether, of the one or more objects on the drag path, any object belongs to an activated drawing area (step B21).

If in step B21 it is determined that none of the objects on the drag path belong to an activated drawing area, the input operation estimation unit 13 ends the process. On the other hand, if in step B21 it is determined that on the drag path there are objects that belongs to an activated drawing area, the input operation estimation unit 13 estimates that the input operation is a plural-object selection operation for objects that belong to the activated drawing area (step B22).

In short, when the starting location is outside an active drawing area, the input operation is estimated to be a plural-object selection operation as described above (see E1 to E6 in FIG. 11). Furthermore, when all the objects on the drag path are objects that belong to a non-drawing area which does not exist in the drawing area data 172, it is estimated that the input operation is a plural-object selection operation because none of the users is doing edit (see steps B18 to B20, and E1 and E2 in FIG. 11).

However, when, regardless of whether another user is doing edit, object selection has been performed so that the drag path extends into or across an active drawing area, only the objects within the active drawing area are selected (see steps B21 and B22, and E3 to E6 in FIG. 11). Thus, with regard to the drag operation, although the switching of active drawing areas does not occur, it is estimated that the input operation is either the graphic drawing or the plural-object selection operation according to the starting location of the drag.

Furthermore, when the drag operation is performed from a non-drawing area into an inactive drawing area, the input operation is not estimated to be either the plural-object selection or the drawing operation (see steps B19 and B21). This avoids affecting a drawing area where another user is doing edit and, in the plural-object selection operation, the drawing area that the user is presently discussing is discriminated from the other drawing areas.

Furthermore, as illustrated in steps B9 to B13 in FIG. 7, in the case where objects are selected by clicking/tapping one at a time, the selection of an object causes activation of an area that contains the object, so that the drawing area selected is always an active drawing area. Thus, in the estimation process 1 and the estimation process 2, even when there are a plurality of drawing areas, a drawing operation can be estimated by switching the active drawing area.

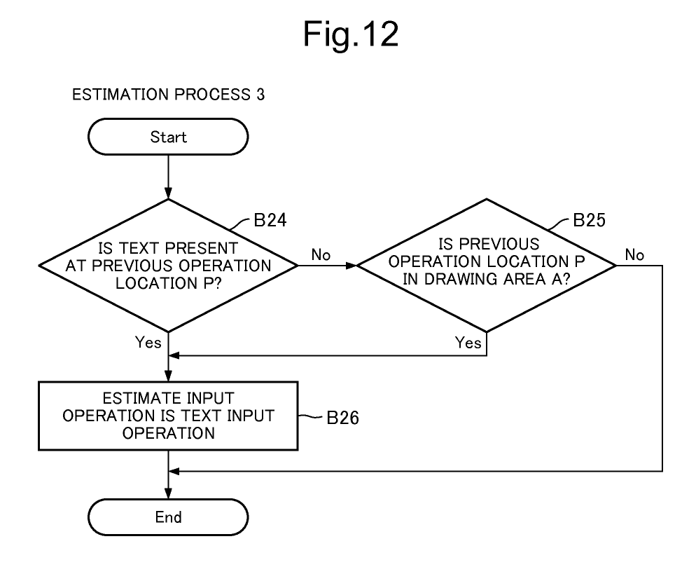

Finally, the estimation process 3 will be described. FIG. 12 is a flowchart specifically illustrating the estimation process 3 indicated in FIG. 6. In FIG. 12, the term “drawing area A” means an active (activated) drawing area. The term “operation location P” means the operation location of clicking or tapping.

As illustrated in FIG. 12, when in step B23 mentioned above it is determined that the input operation is a character input, the input operation estimation unit 13 determines whether there is any text at the previous operation location (step B24).

If in step B24 it is determined that text is present at the previous operation location, the input operation estimation unit 13 estimates that the input operation is a text input operation with respect to a drawing area (step B26) (see C3 in FIG. 8).

On the other hand, if in step B24 it is determined that there is no text at the previous operation location, the input operation estimation unit 13 determines whether the previous operation location is in an activated drawing area (step B25). If in step B25 it is determined that the previous operation location is in an activated drawing area, the input operation estimation unit 13 executes step B26. On the other hand, if in step B25 it is determined that the previous operation location is not in an activated drawing area, the input operation estimation unit 13 ends the process.

Thus, as the foregoing estimation processes 1 to 3 are executed, the command intended by the input operation is estimated. Furthermore, in this exemplary embodiment, each terminal apparatus 10, after estimating an input operation, allows the input operation to continue until the input operation ends or until another input operation is performed. Furthermore, when a user performs clicking/tapping or a drag again in the drawing area, the input operation estimation unit 13 can continuously execute the input operation estimation process.

Object Registration/Sharing Phase:

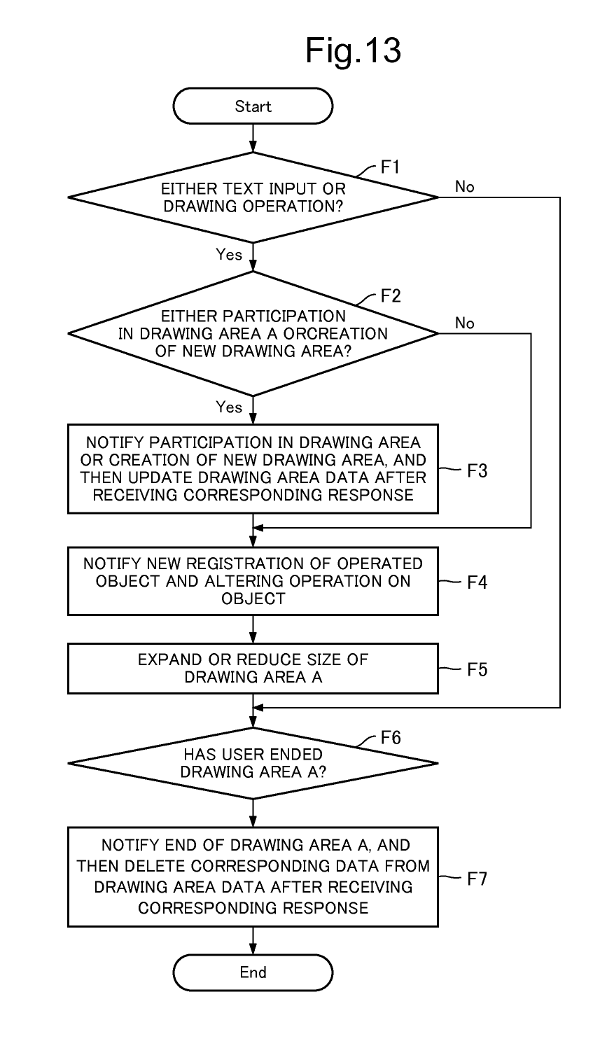

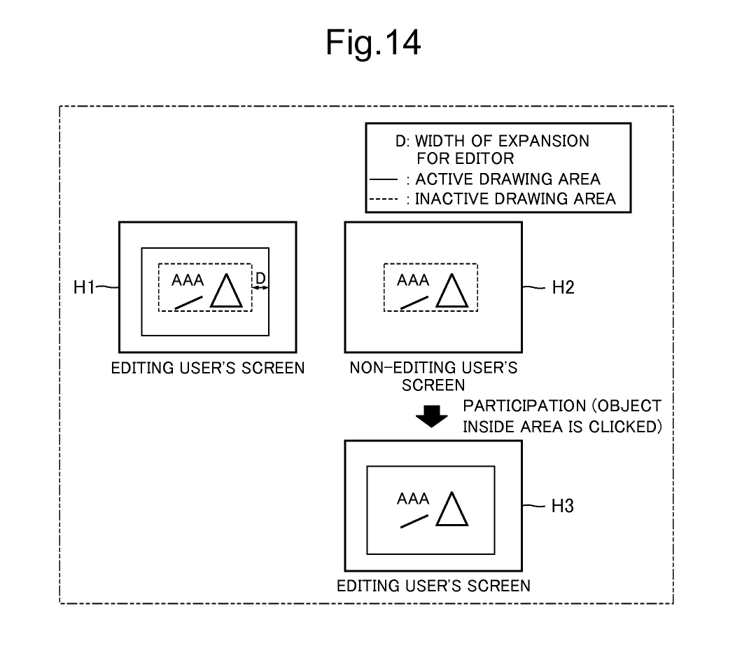

The object registration/sharing phase will be described with reference to FIG. 13 and FIG. 14. FIG. 13 is a flowchart illustrating an operation performed during the object registration/sharing phase of each terminal apparatus in an exemplary embodiment of the present invention. In FIG. 13, the term “drawing area A” means an active (activated) drawing area.

As illustrated in FIG. 13, the data transmitter unit 15 first determines whether the command estimated by the input operation estimation unit 13 is either one of text input or the drawing of a graphic (step F1). If in step F1 it is determined that the estimated command is neither text input nor the drawing of a graphic, the data transmitter unit 15 executes step F6 described below.

On the other hand, if in step F1 it is determined that the estimated command is either text input or the drawing of a graphic, the data transmitter unit 15 determines whether, during the input operation estimation phase, either the participation in the activated drawing area or the creation of a new drawing area has been carried out (step F2). If in step F2 it is determined that neither the participation nor the creation has been carried out, the data transmitter unit 15 executes step F4 described below.

On the other hand, if in step F2 it is determined that either the participation or the creation has been carried out, the data transmitter unit 15 notifies the server apparatus 20 of the participation in the drawing area or the creation of a new drawing area (step F3). By this process, the server apparatus 20 assigns a location ID to the new drawing area, registers the content notified, and then sends information (area information) that indicates the result of the registration. Due to this, the data receiver unit 16 of each terminal apparatus 10 receives the information, and updates the drawing area data 172 using the received information.

Next, the data transmitter unit 15 notifies the server apparatus 20 of the object that is operated on in the drawing area where the user has participated or the object newly registered in the new drawing area (step F4). Specifically, the data transmitter unit 15 sends information (object information) that identifies these objects to the server apparatus 20.

After step F4 is executed, the server apparatus 20 returns the result of registration of the objects and the size of the drawing area. Due to this, the drawing area alteration unit 14 of each terminal apparatus 10 enlarges or reduces the size of the drawing area that the drawing area alteration unit 14 causes the object display unit 11 to display, on the basis of the result of registration of the objects and the size of the drawing area returned (step F5).

Specifically, the drawing area alteration unit 14 calculates various values on the basis of the following mathematical expressions 1 to 5 so that the drawing area for edit that the user uses for edit is larger by a certain amount at each of the top, bottom, left, and right than the drawing area that the server apparatus 20 designates.

In the following mathematical expressions 1 to 5, the symbols are defined as follows: Ax is the x-coordinate of a drawing area; Ay is the y-coordinate of the drawing area; Aw is the width of the drawing area; Ah is the height of the drawing area; Az is the z-order of the drawing area; Ex is the x-coordinate in a drawing area for edit; Ey is the y-coordinate in the drawing area for edit; Ew is the width in the drawing area for edit; Eh is the height in the drawing area for edit; Ez is the z-order in the drawing area for edit; and D is the width of expansion (or the width of reduction) for edit.

Ex=Ax−D (1)

Ey=Ay−D (2)

Ew=Aw+2D (3)

Eh=Ah+2D (4)

Ez=Az (5)

FIG. 14 is a diagram illustrating the expansion-or-reduction operation process for a drawing area for edit illustrated in FIG. 13. As illustrated in FIG. 14, execution of step F5 makes the sizes of a drawing area H1 for an editing user and an original drawing area H2 different from each other.

As a result, in the case where a plurality of users operate on the same electronic whiteboard, the drawing area H2 is displayed in the original size in the screen of a terminal apparatus of a non-editing user who is not doing editing. On the other hand, in this case, the screen of the terminal apparatus of an editing user who is participating in the drawing area displays a comparatively large drawing area H1 so as to facilitate drawing.

In other words, an editing user obtains display of a drawing area that facilitates the editing user's operation, and a non-editing user obtains display of a drawing area that is less likely to interfere with the non-editing user's operation. Incidentally, if a non-editing user participates in the drawing area, the size of the drawing area is automatically changed to a size for edit (see H3).

Next, after execution of step F5, the data transmitter unit 15 determines whether the user has ended the activated drawing area (step F6). If in step F6 it is determined that the user has ended the activated drawing area, the data transmitter unit 15 notifies the server apparatus 20 that the activated drawing area will be ended (step F7).

Due to this, the server apparatus 20 registers the content of notification, and then sends information (area information) that indicates a result of the registration. Then, the data receiver unit 16 receives the information and, on the basis of the received information, deletes the data about the corresponding drawing area from the drawing area data 172.

As described above, the data transmitter unit 15 sends the result of the drawing operation determined during the input operation estimation phase and the content of operation (information about the object location, text content/drag path, the width, the height, the z-order, and the like) as operation information to the server apparatus 20. Using this information, the server apparatus 20 performs new object registration or alteration.

Furthermore, the data receiver unit 16 receives, via the server apparatus 20, information about an object that another user has added and information about a drawing area that another user has added, deleted, or altered, and reflects the information. Therefore, the terminal apparatus 10 allows a plurality of users to share information. The drawing area process on the reception side is merely to reflect the received data, and therefore will not be described.

Operation of Server Apparatus (Whiteboard Providing Apparatus)

Subsequently, operations of the server apparatus 20 will be described separately for the case where a user has performed an operation on a drawing area and the case where a user has performed an operation on an object in a drawing area.

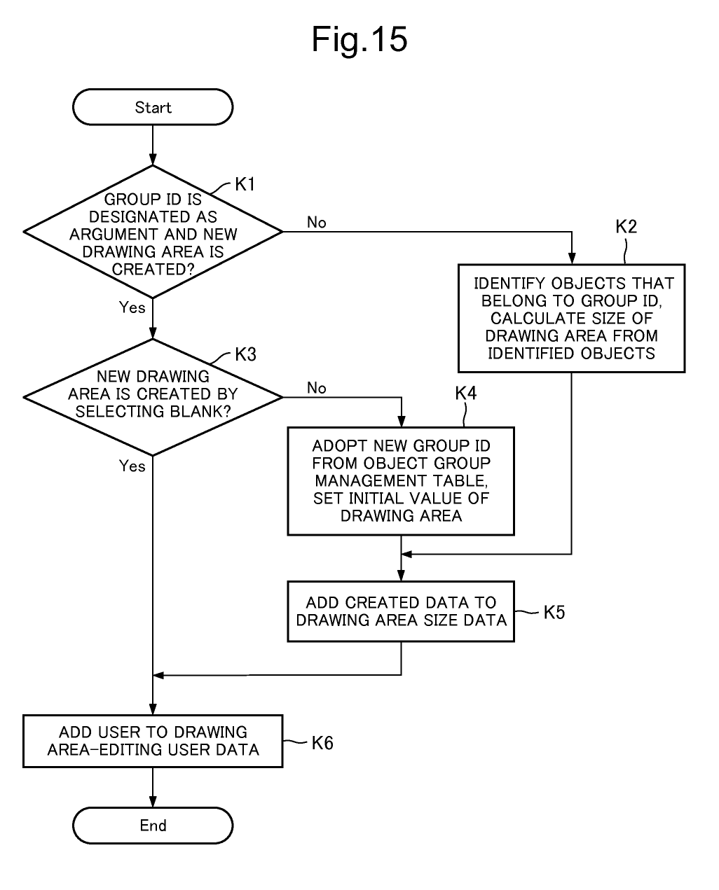

First, description will be given regarding the case where a user has performed an operation on a drawing area, with reference to FIG. 15. FIG. 15 is a flowchart illustrating an operation performed by a server apparatus in an exemplary embodiment of the present invention when a user has performed an operation on a drawing area. It is assumed for the description below that the data receiver unit 21 of the server apparatus 20 has been notified of the creation of a new drawing area, the participation in a drawing area or the end of a drawing area from the data transmitter unit 15 of the terminal apparatus 10. Then, the data receiver unit 21 outputs the received notification to the drawing area management unit 24.

As illustrated in FIG. 15, the drawing area management unit 24 first determines whether the user intends to participate in the drawing area by clicking on an existing object in a non-drawing area (step K1) (see D5 to D8 in FIG. 9). Specifically, the drawing area management unit 24 determines whether, in the notification from the terminal apparatus 10, a group ID is designated as an argument and the creation of a new drawing area is ordered (step K1) (see D5 to D8 in FIG. 9).

If in step K1 it is determined that a group ID is designated and the creation of a new drawing area is ordered, the drawing area management unit 24 searches the object information table 261 by using the notified group ID so as to identify the object or objects that belong to that group (step K2). Furthermore, on the basis of the identified objects, the drawing area management unit 24 calculates the size of the drawing area that needs to be displayed. After that, the drawing area management unit 24 executes step K5 described below.

On the other hand, if in step K1 it is determined that both the designation of a group ID and the order of the creation of a new drawing area are not given, it is the case that the user creates a new drawing area by selecting a blank area. Therefore, in this case, the drawing area management unit 24 adopts a new group ID from the object group management table 264.

Furthermore, the drawing area management unit 24 sets the size of the new drawing area stringed with the new group ID to an initial value (step K4).

Next, the drawing area management unit 24 registers the group ID adopted in step K4 and the initial value of the drawing area in the drawing area size data 271 (step K5).

After that, the drawing area management unit 24 adds the user to the drawing area-editing user data 272 (step K6), and then ends the process. Thus, the drawing area management unit 24 manages the information about the users participating in the drawing area in the drawing area-editing user data 272 indicated in FIG. 4. In other words, the drawing area management unit 24 updates the information stored in the management data storage unit 27 by using the information input thereto.

Furthermore, with regard to the drawing area that no longer has an editing user, the drawing area management unit 24 immediately deletes the data about the drawing area from the management data storage unit 27, and sends a notification of the deletion to the terminal apparatuses 10 of the users who are participating in the same electronic whiteboard. When a new drawing area is not created, the drawing area management unit 24 does not perform any particular process.

In step K2 described above, the drawing area management unit 24 calculates the size of the drawing area on the basis of mathematical expressions 6 to 10 below so that the size of the drawing area is always minimum while being large enough to contain all the objects that belong to the drawing area.

In the mathematical expressions 6 to 10, the symbols are defined as follows: Ox is the x-coordinate in a drawing area; Oy is the y-coordinate in the drawing area; Ow is the width in the drawing area; Oh is the height in the drawing area; and Oz is the z-order in the drawing area.

Ax=min(Ox) (6)

Ay=min(Oy) (7)

Aw=(max(Ox)−min(Ox))+max(Ow) (8)

Ah=(max(Oy)−min(Oy))+max(Oh) (9)

Az=(max(Oz))+1 (10)

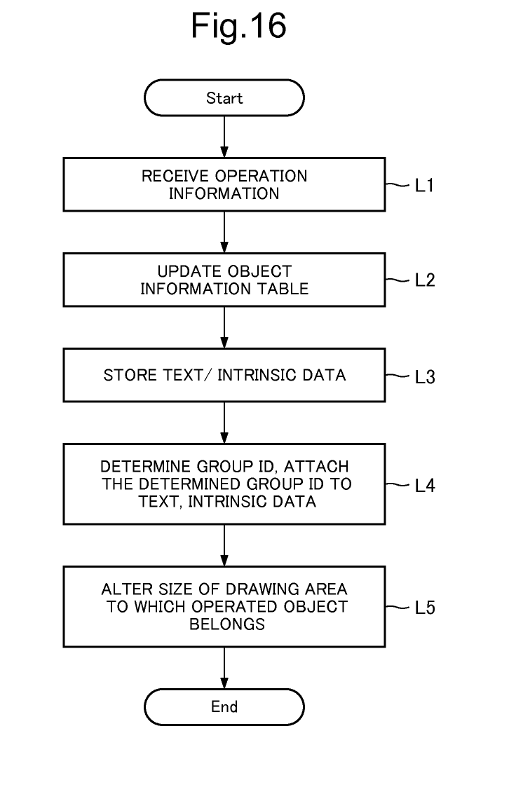

Subsequently, description will be made regarding the case where a user has performed an operation on an object in a drawing area, with reference to FIG. 16. FIG. 16 is a flowchart illustrating an operation performed by a server apparatus in an exemplary embodiment of the present invention when a user has performed an operation on an object in a drawing area.

As illustrated in FIG. 16, the data receiver unit 21 first receives operation information regarding new object registration or operation information regarding alteration of an object from a terminal apparatus 10, and inputs the received information to the drawing-object operation processing unit 23 (step L1).

Next, the drawing-object operation processing unit 23, using the input operation information, updates the object information table 261 stored in the whiteboard data storage unit 26 (step L2).

Next, the drawing-object operation processing unit 23 causes the whiteboard data storage unit 26 to store information intrinsic to the object, such as the content of text, the drag path, and the like, as text/graphic intrinsic data 262 (step L3).

Next, the drawing-object operation processing unit 23 specifically determines a group ID from the drawing area IDs contained in the received operation information, and attaches the determined group ID to the text/graphic intrinsic data 262, and thus registers the determined group ID (step L4).

After step L4 is executed, the drawing area management unit 24 alters the size of the drawing area to which the operation object belongs (step L5), and ends the process. Incidentally, in step L5, too, the drawing area management unit 24 calculates the size of the drawing area on the basis of the mathematical expressions 6 to 10.

The results of the operation described above (information about the operation object and information about registration and alteration of the drawing area) are sent not only to the terminal apparatus 10 of the user who sent the operation information but also to the terminal apparatuses 10 of other users who are looking at the same electronic whiteboard.

Furthermore, whether users are looking at the same whiteboard is determined on the basis of the participant data 263 (see FIG. 5). When a terminal apparatus 10 has activated an application program for utilizing the electronic whiteboard, the participant data 263 is registered on the basis of information that the terminal apparatus 10 retains. After receiving results of operation at the data receiver unit 16, the terminal apparatus 10 reflects the results of operation in the screen by using the object display unit 11. According to this exemplary embodiment, even when a plurality of users perform an operation (have discussion) on an electronic whiteboard, information about the object and the drawing area can be shared.

Advantageous Effects of Exemplary Embodiment

As described above, in this exemplary embodiment, each terminal apparatus 10 can estimate the command that a user intends by an input operation, without limiting input methods. Therefore, regardless of which one of PCs, smart phones, tablet-type terminals, and the like is used as a terminal apparatus 10, the burden of a user in performing input operations when using an electronic whiteboard can be reduced without restriction on input methods.

Furthermore, according to this exemplary embodiment, it is possible to cope with the case where a plurality of users simultaneously use an electronic whiteboard, and information can be shared among users. Further, even when a plurality of users work together to perform drawing, the burden on the users in input operation is reduced.

Further, in the exemplary embodiment, since the automatic switching of operation is performed among text input, graphic drawing, and selection of a plurality of objects, the operability of users can be improved in the case where text and graphics coexist in the electronic whiteboard.

Modification 1

In this exemplary embodiment, the input operation estimation unit 13 can determine whether the starting point of a drag is on a text object after the determination regarding the drawing area activated by the drag operation. In this case, the input operation estimation unit 13 can estimate that the input operation is not a drawing operation but text range selection from a result of the determination.

Modification 2

In this exemplary embodiment, the input operation estimation unit 13 can cope with other input operations. For example, let it assumed that as an input operation, a click-and-hold of the mouse button or a tap-and-hold on a touch panel terminal is performed. In this case, the input operation estimation unit 13 can be equipped with, for example, a function of estimating that an input operation performed in a drawing area is an operation for adjusting the weight of the font or the line weight of a drawing pen. This added function allows an operation of emphasizing a part that is important in a discussion (operation of overwriting or overdrawing an existing part with a bold typeface or line). If a setting is made such that when the weight of the font or pen exceeds a certain value the weight is returned to an initial value, it becomes possible to cope with an excessively long-time hold of the mouse button or the touch panel surface.

Modification 3

In this exemplary embodiment, a graphic recognition system that recognizes the shapes of graphics can be used. The graphic recognition system is a system that shapes a freehand-drawn graphic when line information about the freehand-drawn graphic is input. Furthermore, if a plurality of lines which each branch into two or more lines and intersect and whose operation sequence is continuous are input together, complicated graphics can be coped with.

Modification 4

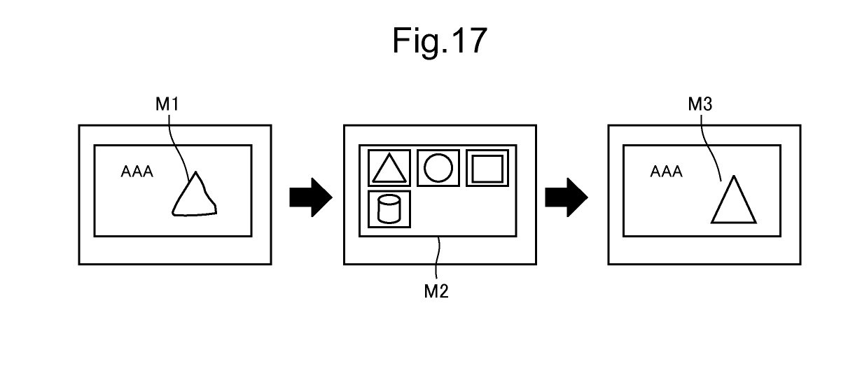

When a freehand-drawn graphic needs to be shaped in an environment where the foregoing graphic recognition system is not allowed to be used, the input operation estimation unit 13 is caused, as illustrated in FIG. 17, to display object selection buttons M2 if a graphic M1 is drawn by a drag operation after it is determined that the input operation is a drawing operation. In this case, the user selects from the selection buttons M2 a graphic that resembles the drawn graphic. As a result, a shaped graphic M3 is displayed in the screen. FIG. 17 is a diagram illustrating Modification 4 of the exemplary embodiment of the present invention.

Modification 5

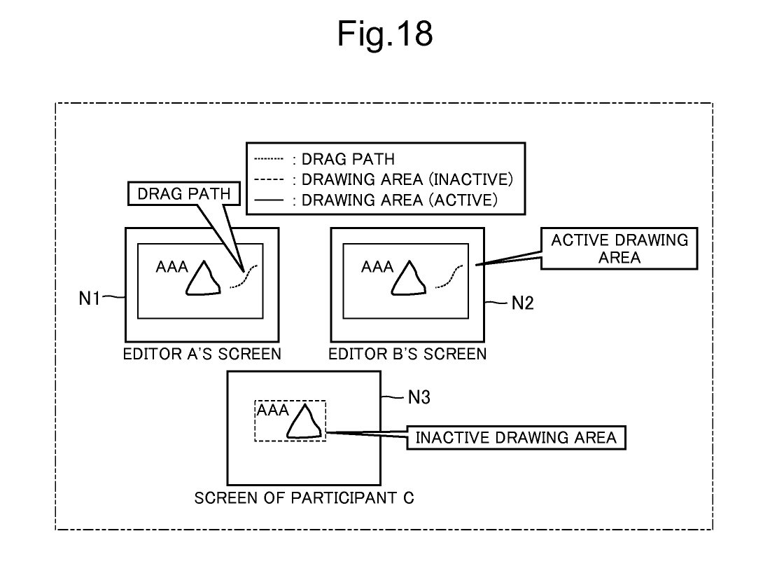

Furthermore, in the exemplary embodiment, the server apparatus 20 can identify the editor or editors of a drawing area. Therefore, as illustrated in FIG. 18, the server apparatus 20 can cause only the editing users of the drawing area to share the process from the start to the end of the input operation, for example, the drawing path, of each editing user before the server apparatus 20 registers the objects. In this case, each editing user can immediately grasp what another editing user presently intends to draw, so that the operability at the time of a collaborated edit improves. FIG. 18 is a diagram illustrating Modification 5 of the exemplary embodiment of the present invention.

In other words, in each of the terminal apparatuses 10 of the editing users participating in the drawing area, the data transmitter unit 15 sends information that indicates the process from the start to the end of the input operation to the server apparatus 20. In this case, the data transmitter unit 22 of the server apparatus 20 sends the information from the terminal apparatus 10 of an editing user to the terminal apparatuses 10 of the other editing users, and causes the screen of each of the terminal apparatuses 10 to display information that represents the process of from the start to the end of the input operation.

Specifically, the data transmitter unit 15 of the terminal apparatus 10 of each user sends the drag path and the character input to the server apparatus 20 point by point, and the server apparatus 20, at every time of transmission, sends updated information to the other editing users by using the drawing area-editing user data 272. In this manner, the foregoing sharing can be realized (see N1 and N2 in FIG. 18). In this case, the users who are not participating in the drawing area cannot see the drag path nor the character input (see N3 in FIG. 18).

Modification 6

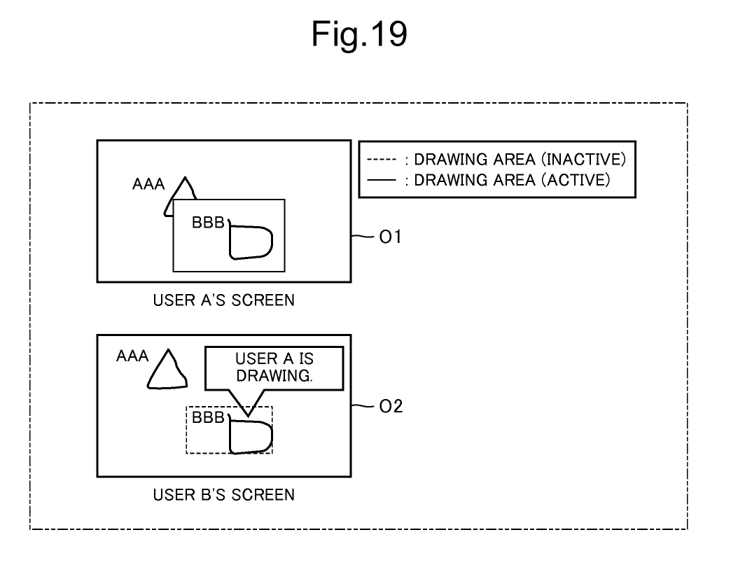

In the exemplary embodiment, the users participating in the drawing area can be identified by using the editing user information of the drawing area-editing user data 272. Therefore, as illustrated in FIG. 19, when a user performs an operation, such as clicking/tapping on an inactive drawing area displayed in the screen by the object display unit 11 or positioning the cursor onto this non-drawing area, the server apparatus 20 sends information indicating that this user has participated in the drawing area to the terminal apparatuses 10 of the users other than this user. Due to this, in each of the terminal apparatuses 10 of the users to which the information has been sent, the object display unit 11 can display an indication about the user who is participating in the drawing area (see O2 in FIG. 19). FIG. 19 is a diagram illustrating Modification 6 of the exemplary embodiment of the present invention.

Modification 7

In the exemplary embodiment, each terminal apparatus 10 displays an activated drawing area distinctively from other drawing areas in the display screen. At this time, each terminal apparatus 10 can also display the individual drawing areas distinctively by varying the presentation manners of the drawing areas.

Modification 8

In the exemplary embodiment, the server apparatus 20 can allow a user who selects an object in the active drawing area to recognize the situation of operation performed on the object by other users. If at that time, the selected object is being edited by another user, the server apparatus 20 can set a restriction such that the object is not allowed to be changed, for example, is not allowed to be moved or altered.

Modification 9

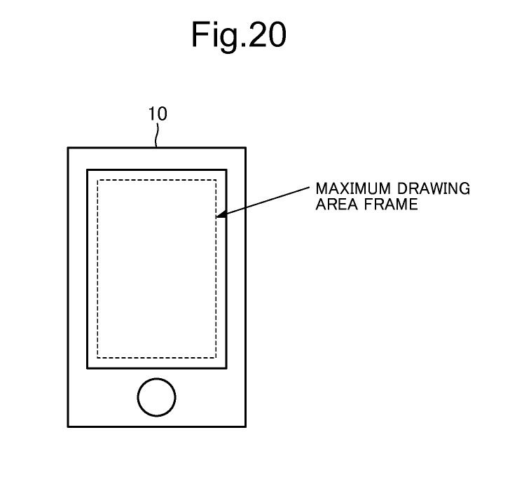

In the exemplary embodiment, when a terminal apparatus 10 is an apparatus whose screen size is restricted, such as smart phone, a restriction can be set such that the size of any activated drawing area can be enlarged only to a size that is slightly smaller than the display screen (to a maximum drawing area frame), as illustrated in FIG. 20. Due to this, even when an activated drawing area is increased in size, the user can selectively perform drawing and selection. Furthermore, since the size of each drawing area in the screen is altered by the drawing area alteration unit 14, the original size of each drawing area is not affected. FIG. 20 is a diagram illustrating Modification 9 of the exemplary embodiment of the present invention.

Modification 10

Drawing areas are displayed in the screen by the object display unit 11. At that time, the size of each drawing area is calculated on the basis of a returned value from the server apparatus 20. If the communication speed decreases, the response speed in display of drawing areas decreases. To avoid this situation, the drawing area alteration unit 14 can calculate the size of a drawing area by applying the display object data 171 to the mathematical expressions 6 to 10 as in step K2 in FIG. 15 when the communication speed has decreased.

Modification 11

During the input operation estimation phase, if a user performs an input operation for deleting an object displayed in the screen, the input operation estimation unit 13 deletes the designated object, and updates the display object data 171. Furthermore, in response to this, the server apparatus 20 accepts the deletion process for the object, and deletes the corresponding data from the object information table 261. Then, the drawing area management unit 24 re-calculates the size of the drawing area. If the re-calculation results in a reduced size of the drawing area, the object display unit 11 of the terminal apparatus 10 reduces the size of the corresponding drawing area.

Modification 12

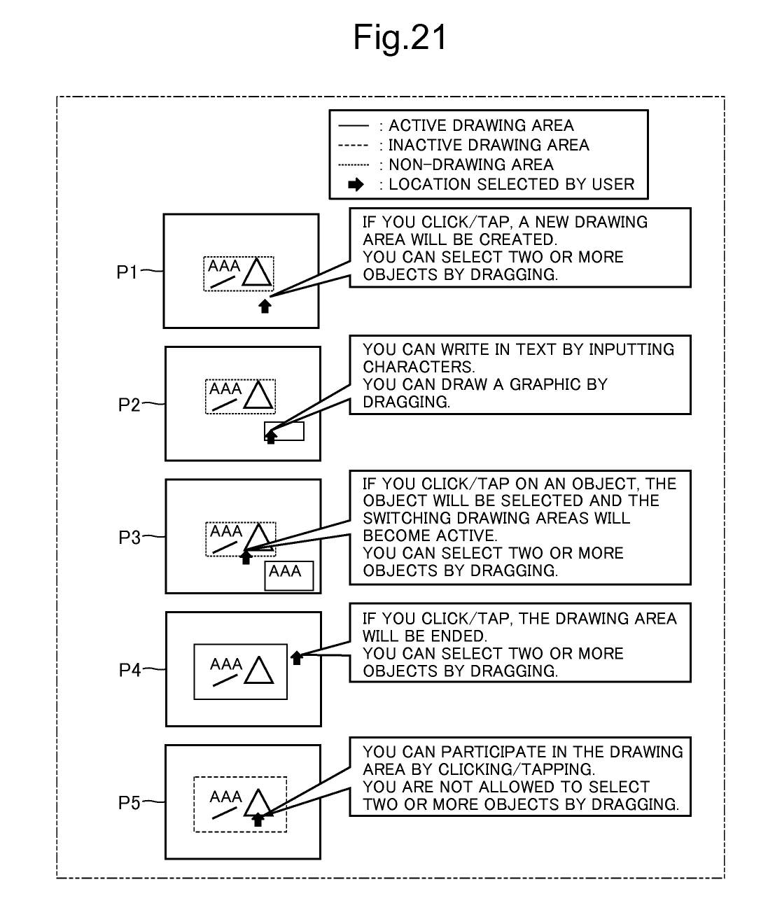

In the exemplary embodiment, each terminal apparatus 10 may be equipped with an arrangement that, at the time of estimation of an input operation, reminds a user of an input operation that the user is scheduled to perform so that the user is prevented from performing an incorrect operation. For example, as illustrated in FIG. 21, when the user performs the positioning of the cursor, a click-and-hold or a tap-and-hold, or the like, the terminal apparatus 10 can estimate a scheduled operation according to the selected position and present the estimated scheduled operation (see P1 to P5 in FIG. 21). FIG. 21 is a diagram illustrating Modification 12 of the exemplary embodiment of the present invention.

Modification 13

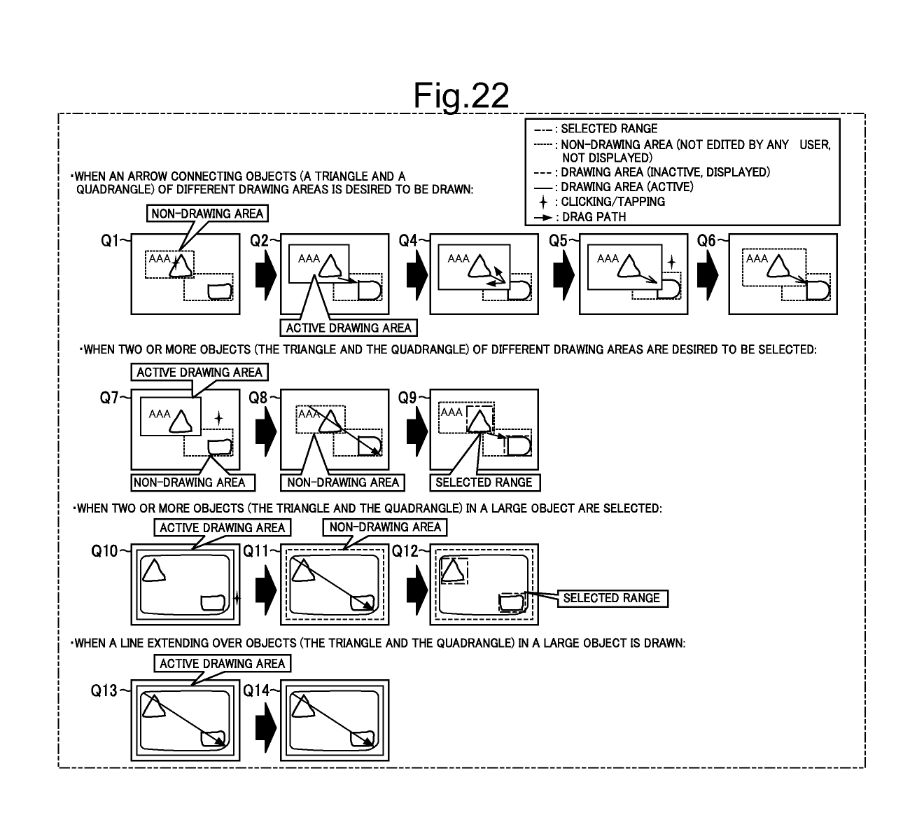

As illustrated in FIG. 22, for example, when a user of a terminal apparatus 10 desires to draw an arrow between objects that belong to different drawing areas, the arrow can be drawn by activating one of the drawing areas and dragging from inside the activated drawing area (see Q1 to Q6). FIG. 22 is a diagram illustrating Modification 13 of the exemplary embodiment of the present invention.

Furthermore, as illustrated in FIG. 22, when the user of the terminal apparatus 10 selects objects of different drawing areas (see Q7 to Q9), or when the user selects a plurality of objects (a triangle and a quadrangle) present in a large object (see Q10 to Q12), the user ends the drawing area or areas. This forces a switch to the selection operation, enabling the selection of the objects.

Still further, as illustrated in FIG. 22, when the user of the terminal apparatus 10 draws a line over a plurality of objects (a triangle and a quadrangle) in a large object, the drawing is enabled if the user performs a drag operation in the active drawing area (see Q13 to Q14).

Modification 14

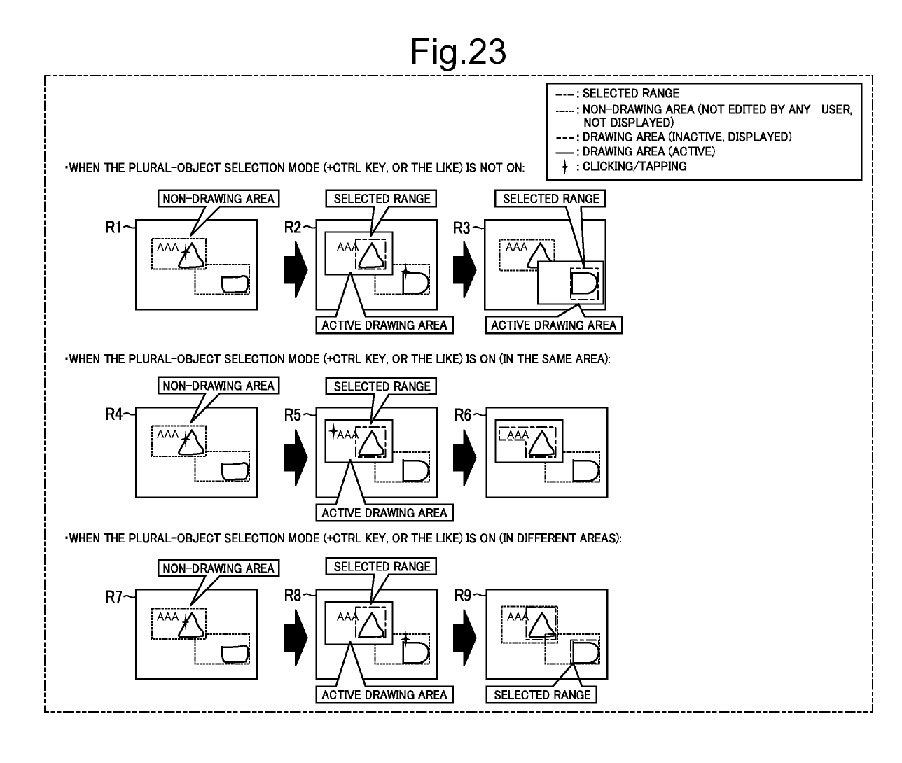

The exemplary embodiment can cope with the case where a user wants to perform an operation of selecting two or more objects by clicking/tapping. In this case, the input operation estimation unit 13 determines whether the plural-object selection mode is on. Specifically, as illustrated in FIG. 23, the input operation estimation unit 13, if in a PC, determines whether the user has clicked while holding the Ctrl key down, and, if in a smart phone, displays a plural-object selection button and then determines whether the user has turned on the plural-object selection button prior to tapping. FIG. 23 is a diagram illustrating Modification 14 of the exemplary embodiment of the present invention.

If it is determined that the plural-object selection mode is on, the input operation estimation unit 13 executes selection of a plurality of objects in the same area (see R4 to R6) or selection of a plurality of objects of different areas (see R7 to R9). The selection of a plurality of objects of different areas is performed over a plurality of drawing areas. Therefore, at this time of selection, the user temporarily ends the activated drawing area (see R9).

Modification 15

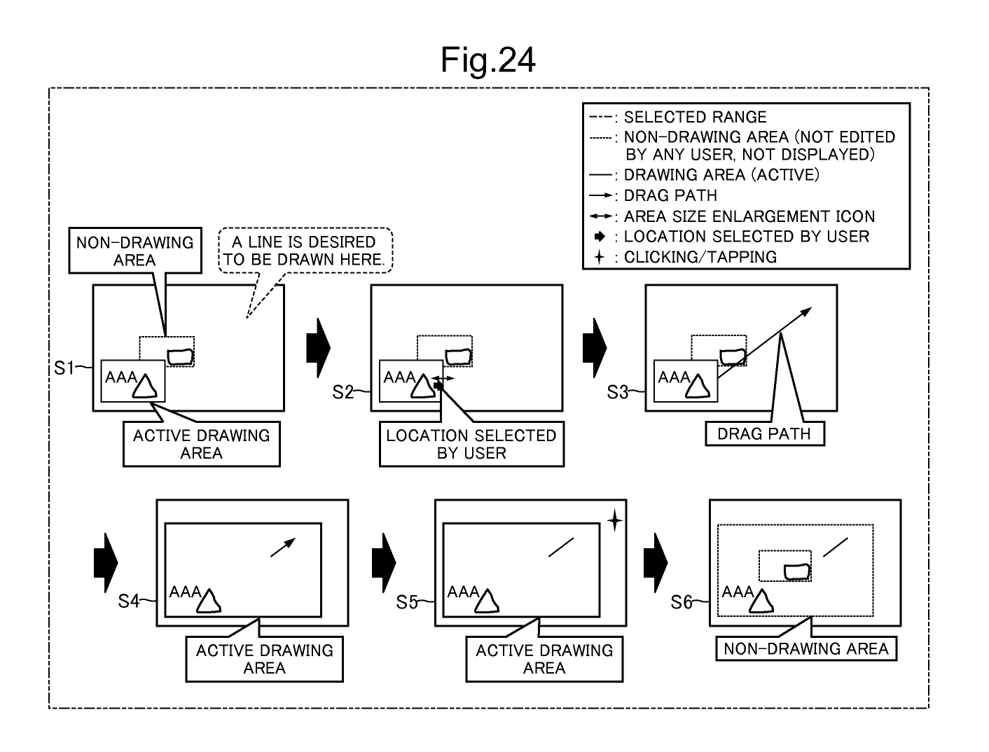

In the exemplary embodiment, as illustrated in FIG. 24, the user can draw a graphic at a place away from an existing drawing area as an object that belongs to the same existing drawing area (see S1). In this case, the user can enlarge the drawing area by dragging from an edge of the drawing area, and therefore can draw a graphic at a place away from the existing object of the drawing area (see S2 to S6). FIG. 24 is a diagram illustrating Modification 15 of the exemplary embodiment of the present invention.

In this case, the terminal apparatus 10 can display an area size enlargement icon in order to inform the user that the drawing area can be enlarged (see S2). Furthermore, the terminal apparatus 10 is also able to reduce the enlarged drawing area. However, if the reduced size of the drawing area is smaller than the size registered in the drawing area data 172, the layout of the objects will be lost. Therefore, if the terminal apparatus 10 is enabled to reduce drawing areas, it is preferable that terminal apparatus 10 set a restriction on the width of reduction.

Modification 16

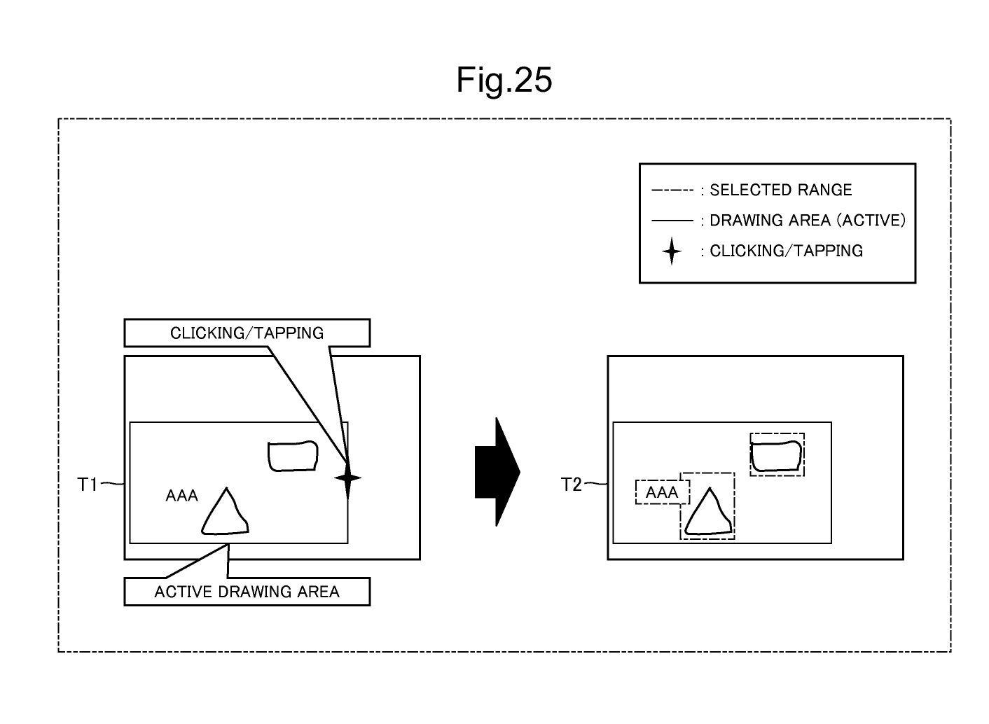

In order for users to easily move a whole drawing area when the drawing area becomes large and the number of objects in the drawing area becomes great, each terminal apparatus 10 may be equipped with an arrangement for selecting the objects in a drawing area altogether. For example, the input operation estimation unit 13 may be equipped with a function of selecting all the objects in a drawing area when a user clicks/taps on an edge of the drawing area as illustrated in FIG. 25. FIG. 25 is a diagram illustrating Modification 16 of the exemplary embodiment of the present invention.

Program

It suffices that a program in the exemplary embodiment is a program that causes a computer that functions as a terminal apparatus to execute the process of steps B1 to B26 illustrated in FIG. 6, FIG. 7, FIG. 10, and FIG. 12, and the process of steps F1 to F7 illustrated in

FIG. 13. By installing this program in the computer so as to be executed by the computer, the terminal apparatus 10 and the input assist method for the electronic whiteboard in the exemplary embodiment can be realized. In this case, a central processing unit (CPU) of the computer functions as the object display unit 11, the input operation identification unit 12, the input operation estimation unit 13, the drawing area alteration unit 14, the data transmitter unit 15, and the data receiver unit 16, and perform the processes.

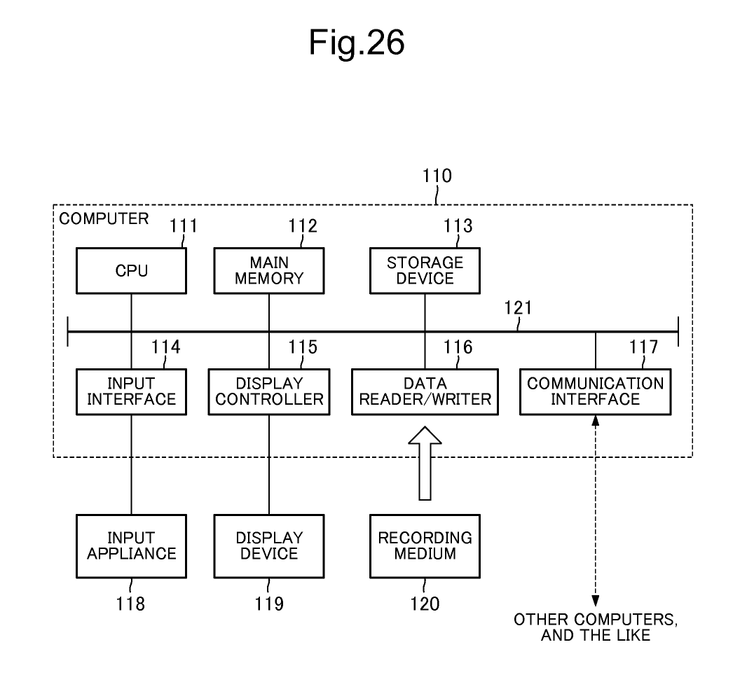

An example of the computer that realizes the terminal apparatus 10 by executing the program in the exemplary embodiment will be described with reference to FIG. 26. FIG. 26 is a block diagram illustrating an example of the computer that realizes the terminal apparatus in the exemplary embodiment of the present invention.

As illustrated in FIG. 26, a computer 110 includes a CPU 111, a main memory 112, a storage device 113, an input interface 114, a display controller 115, a data reader/writer 116, and a communication interface 117. These units are interconnected by a bus 121 so that data communication therebetween can be performed.

The CPU 111 decompresses in the main memory 112 the program (codes) in the exemplary embodiment stored in the storage device 113, and executes the program in a predetermined sequence to carry out various computations. The main memory 112 is typically a volatile storage device such as a dynamic random access memory (DRAM). The program in the exemplary embodiment is provided in a state in which the program is stored in a recording medium 120 that is readable by the computer. The program in the exemplary embodiment may be a program that is distributed on the Internet to which the computer 110 is connected via the communication interface 117.

Specific examples of the storage device 113 include a hard disk drive, and a semiconductor storage device such as a flash memory. The input interface 114 intermediates in the data transfer between the CPU 111 and an input appliance 118 such as a keyboard and a mouse. The display controller 115 is connected to a display device 119, and controls the display in the display device 119.

The data reader/writer 116 intermediates in the data transfer between the CPU 111 and the recording medium 120, reads programs from the recording medium 120, and writes results of processing performed in the computer 110 into the recording medium 120. The communication interface 117 intermediates in the data transfer between the CPU 111 and other computers.

Specific examples of the recording medium 120 include general-purpose semiconductor storage devices such as a Compact Flash (CF (registered trademark)) and a Secure Digital (SD) device, magnetic storage media such as flexible disks, and optical storage media such as a compact disk read-only memory (CD-ROM).

A part or the whole of the foregoing exemplary embodiment can be expressed by (Supplemental Note 1) to (Supplemental Note 15) mentioned below, but is not limited to what is described below.

(Supplemental Note 1) A terminal apparatus that includes:
an object display unit that sets, at an indicated place in an electronic whiteboard displayed in a screen, a drawing area in which objects that include text and graphics are permitted to be drawn;
an input operation identification unit that identifies content of an input operation performed on the electronic whiteboard; and
an input operation estimation unit that estimates a command intended by the input operation, based on identified content of the input operation and a relation between a location in the screen at which the input operation has been performed and a location of the drawing area.

(Supplemental Note 2) The terminal apparatus described in Supplemental Note 1 wherein:
the input operation identification unit identifies which one of designation of one point in the screen, designation of two or more points in the screen, or input of text into the screen has been performed as the input operation; and
the input operation estimation unit estimates which one of the input of text, selection of an object, or drawing of a graphic corresponds to the input operation, based on the identified content of the input operation and the relation between the location in the screen at which the input operation has been performed and the location of the drawing area.

(Supplemental Note 3) The terminal apparatus described in Supplemental Note 1 or 2
further including a data transmitter unit, wherein
when the electronic whiteboard is provided on a network by a server apparatus,
the data transmitter unit, if the input operation has caused a change in the drawing area, sends information that identifies the change caused to the server apparatus, so that the data transmitter unit causes the server apparatus to update information displayed in the electronic whiteboard, based on the information that identifies the change.

(Supplemental Note 4) The terminal apparatus described in Supplemental Note 3
further including a drawing area alteration unit that changes a size of the drawing area according to an order from the server apparatus.

(Supplemental Note 5) The terminal apparatus described in Supplemental Note 3 or 4
further including a data receiver unit that receives from the server apparatus a result caused by the input operation and a result of the input operation performed in another terminal apparatus that utilizes the electronic whiteboard, wherein
the data receiver unit causes the object display unit to update the electronic whiteboard in the screen by using the results received.

(Supplemental Note 6) An electronic whiteboard system that includes:
a server apparatus that provides an electronic whiteboard on a network; and a terminal apparatus for entering an input to the electronic whiteboard, wherein
the terminal apparatus includes: an object display unit that sets, at an indicated place in the electronic whiteboard displayed in a screen, a drawing area in which objects that include text and graphics are permitted to be drawn; an input operation identification unit that identifies content of an input operation performed on the electronic whiteboard; and an input operation estimation unit that estimates a command intended by the input operation, based on identified content of the input operation and a relation between a location in the screen at which the input operation has been performed and a location of the drawing area.

(Supplemental Note 7) The electronic whiteboard system described in Supplemental Note 6, wherein
the server apparatus includes a drawing area management unit that manages information that identifies the drawing area set by the terminal apparatus, information that identifies an object drawn in the drawing area, and information that identifies a user of the terminal apparatus who is performing the input operation in the drawing area.

(Supplemental Note 8) The electronic whiteboard system described in Supplemental Note 6 or 7 wherein
in the terminal apparatus, the input operation identification unit identifies which one of designation of one point in the screen, designation of two or more points in the screen, or input of text into the screen has been performed as the input operation, and the input operation estimation unit estimates which one of the input of text, selection of an object, or drawing of a graphic corresponds to the input operation, based on the identified content of the input operation and the relation between the location in the screen at which the input operation has been performed and the location of the drawing area.

(Supplemental Note 9) The electronic whiteboard system described in any one of Supplemental Notes 6 to 8 wherein:
the terminal apparatus further includes a data transmitter unit;
the server apparatus further includes a drawing-object operation processing unit;
in the terminal apparatus, when the input operation has caused a change in the drawing area, the data transmitter unit sends information that identifies the change to the server apparatus; and
in the server apparatus, when the information is received from the terminal apparatus, the drawing-object operation processing unit updates, based on the information received, information displayed in the electronic whiteboard.

(Supplemental Note 10) The electronic whiteboard system described in Supplemental Note 9
including a plurality of the terminal apparatus, wherein
the server apparatus further includes a transmitter unit that, when the information has been received from any one of the plurality of the terminal apparatus and information displayed in the electronic whiteboard has been updated by the drawing-object operation processing unit, sends content of update carried out in the electronic whiteboard to all the plurality of the terminal apparatus.

(Supplemental Note 11) The electronic whiteboard system described in Supplemental Note 10 wherein
in the server apparatus, when the drawing area management unit identifies users participating in the drawing area among users of the plurality of the terminal apparatus, the transmitter unit sends, to the terminal apparatus of each user identified, information that indicates that at least one identified user is participating in the drawing area.

(Supplemental Note 12) The electronic whiteboard system described in Supplemental Note 11 wherein
in the terminal apparatus that has received the information from the server apparatus, the object display unit displays in the screen the at least one identified user.

(Supplemental Note 13) The electronic whiteboard system described in Supplemental Note 11 wherein
when in the terminal apparatus of one of the identified users, the data transmitter unit sends information that indicates a process from a start to an end of the input operation to the server apparatus,
the transmitter unit in the server apparatus sends the information that indicates the process from the start to the end of the input operation received to the terminal apparatus of at least one other identified user, and causes the information that indicates the process from the start to the end of the input operation to be displayed in the screen of the terminal apparatus.

(Supplemental Note 14) The electronic whiteboard system described in Supplemental Note 9 wherein:
the terminal apparatus further includes a drawing area alteration unit that changes a size of the drawing area according to an instruction from the server apparatus; and
when the data transmitter unit in the terminal apparatus sends, as the information, information that identifies a newly set drawing area or information that identifies a change of an object in the drawing area that has already been set to the server apparatus, the drawing area management unit in the server apparatus instructs the terminal apparatus that has sent the information to enlarge the newly set drawing area or the drawing area in which the object has been changed.

(Supplemental Note 15) An input assist method for an electronic whiteboard wherein
a computer (a) sets, at an indicated place in the electronic whiteboard displayed in a screen, a drawing area in which objects that include text and graphics are permitted to be drawn, (b) identifies content of an input operation performed on the electronic whiteboard, and (c) estimates a command intended by the input operation, based on identified content of the input operation and a relation between a location in the screen at which the input operation has been performed and a location of the drawing area.

(Supplemental Note 16) The input assist method for the electronic whiteboard described in Supplemental Note 15 wherein:
in (b) mentioned above, the computer identifies which one of designation of one point in the screen, designation of two or more points in the screen, or input of text into the screen has been performed as the input operation; and
in (c) mentioned above, the computer estimates which one of the input of text, selection of an object, or drawing of a graphic corresponds to the input operation, based on the identified content of the input operation and the relation between the location in the screen at which the input operation has been performed and the location of the drawing area.

(Supplemental Note 17) The input assist method for the electronic whiteboard described in Supplemental Note 15 or 16 wherein
when the electronic whiteboard is provided on a network by a server apparatus,
the computer also (d) sends information that identifies a change caused in the drawing area by the input operation to the server apparatus if the change occurs, and
the server apparatus updates information displayed in the electronic whiteboard, based on the information received from the computer.

(Supplemental Note 18) The input assist method for the electronic whiteboard described in Supplemental Note 17 wherein
the computer also (e) changes a size of the drawing area according to an instruction from the server apparatus.

(Supplemental Note 19) The input assist method for the electronic whiteboard described in Supplemental Note 17 or 18 wherein
the computer also (f) receives from the server apparatus a result caused by the input operation and a result of an input operation performed in another terminal apparatus that uses the electronic whiteboard, and (g) updates the electronic whiteboard in the screen by using the results received in (f) mentioned above.

(Supplemental Note 20) A non-transitory computer-readable recording medium storing
a program that causes a computer to execute processes of (a) setting, at an indicated place in the electronic whiteboard displayed in a screen, a drawing area in which objects that include text and graphics are permitted to be drawn, (b) identifying content of an input operation performed on the electronic whiteboard, and (c) estimating a command intended by the input operation, based on identified content of the input operation and a relation between a location in the screen at which the input operation has been performed and a location of the drawing area.

(Supplemental Note 21) The non-transitory computer-readable recording medium described in Supplemental Note 20 storing
the program that causes the computer to execute processes of, in (b) mentioned above, identifying which one of designation of one point in the screen, designation of two or more points in the screen, or input of text into the screen has been performed as the input operation, and
in (c) mentioned above, estimating which one of the input of text, selection of an object, or drawing of a graphic corresponds to the input operation, based on the identified content of the input operation and the relation between the location in the screen at which the input operation has been performed and the location of the drawing area.

(Supplemental Note 22) The non-transitory computer-readable recording medium described in Supplemental Note 20 or 21 wherein:
when the electronic whiteboard is provided on a network by a server apparatus,
the program also causes the computer to execute a process of (d) sending information that identifies a change caused in the drawing area by the input operation to the server apparatus if the change occurs, and
the server apparatus updates information displayed in the electronic whiteboard, based on the information that identifies the change.

(Supplemental Note 23) The non-transitory computer-readable recording medium described in Supplemental Note 22 wherein
the program also causes the computer to execute a process of (e) changing a size of the drawing area according to an instruction from the server apparatus.

(Supplemental Note 24) The non-transitory computer-readable recording medium described in Supplemental Note 22 or 23 wherein
the program also causes the computer to execute processes of (f) receiving from the server apparatus a result caused by the input operation and a result of an input operation performed in another terminal apparatus that uses the electronic whiteboard, and (g) updating the electronic whiteboard in the screen by using the results received in the step (f).

In order to apply the technology disclosed in Japanese Laid-open Patent Publication No. 2013-114593 to an electronic whiteboard, the terminal apparatus of each user needs to be equipped with a special pen device, giving rise to a problem that the terminal apparatuses that can be used are limited. Furthermore, because the location of the pen device is a criterion, there is also a possibility that erroneous operations may be caused by a user pressing the wrong button or the like when operating button objects in the screen.

Furthermore, while the technology disclosed in Japanese Patent Publication No. 4301842 is limited only to the selection operation, operations other than the selection operation, such as text input and the drawing of graphics, are also needed in order to realize discussion among users on the electronic whiteboard. Therefore, the technology disclosed in Japanese Patent Publication No. 4301842 has a problem of being difficult to apply to the electronic whiteboard.

Still further, when the switching between operations is realized by the right-clicking the mouse or entering a shortcut key, the technology disclosed in Japanese Patent Publication No. 4301842 has a problem that the terminal apparatuses that can be used are limited, as in the technology disclosed in Japanese Laid-open Patent Publication No. 2013-114593.

Thus, an example of the advantageous effects of the present invention is that, in connection of the use of an electronic whiteboard, the burden on the user in input operation can be reduced without restriction on input methods.

Thus, according to the present invention, in connection of the use of an electronic whiteboard, the burden on the user in input operation can be reduced without restriction on input methods. The present invention is useful for electronic whiteboards and, in particular, on-line whiteboards.

While the present invention has been described with reference to the exemplary embodiment, the present invention is not limited to the above-mentioned exemplary embodiment. Various changes, which a person skilled in the art can understand, can be added to the composition and the details of the invention of the present application in the scope of the invention of the present application.

### REFERENCE SIGNS LIST

10 terminal apparatus

11 object display unit

12 input operation identification unit

13 input operation estimation unit

14 drawing area alteration unit

15 data sender unit

16 data receiver unit

17 data storage unit

20 server apparatus

21 data receiver unit

22 data sender unit

23 drawing-object operation processing unit

24 drawing area management unit

26 whiteboard data storage unit

27 management data storage unit

100 electronic whiteboard system

110 computer

111 CPU

112 main memory

113 storage device

114 input interface

115 display controller

116 data reader/writer

117 communication interface

118 input appliance

119 display device

120 recording medium

121 bus

171 display object data

172 drawing area data

261 object information table

262 text/graphic intrinsic data

263 participant data

264 object group management table

271 drawing area size data

272 drawing area-editing user data

1. A terminal apparatus comprising:
an object display unit that sets, at an indicated place in an electronic whiteboard displayed in a screen, a drawing area in which objects that include text and graphics are permitted to be drawn;
an input operation identification unit that identifies content of an input operation performed on the electronic whiteboard; and
an input operation estimation unit that estimates a command intended by the input operation, based on identified content of the input operation and a relation between a location in the screen at which the input operation has been performed and a location of the drawing area.

2. The terminal apparatus according to claim 1 wherein:
the input operation identification unit identifies which one of designation of one point in the screen, designation of two or more points in the screen, or input of text into the screen has been performed as the input operation; and
the input operation estimation unit estimates which one of the input of text, selection of an object, or drawing of a graphic corresponds to the input operation, based on the identified content of the input operation and the relation between the location in the screen at which the input operation has been performed and the location of the drawing area.

3. The terminal apparatus according to claim 1 further comprising a data transmitter unit, wherein
when the electronic whiteboard is provided on a network by a server apparatus, the data transmitter unit, if the input operation has caused a change in the drawing area, sends information that identifies the change caused to the server apparatus, so that the data transmitter unit causes the server apparatus to update information displayed in the electronic whiteboard, based on the information that identifies the change.

4. The terminal apparatus according to claim 3 further comprising a drawing area alteration unit that changes a size of the drawing area according to an order from the server apparatus.

5. The terminal apparatus according to claim 3 further comprising a data receiver unit that receives from the server apparatus a result caused by the input operation and a result of the input operation performed in another terminal apparatus that utilizes the electronic whiteboard, wherein
the data receiver unit causes the object display unit to update the electronic whiteboard in the screen by using the results received.

6. An electronic whiteboard system comprising:
a server apparatus that provides an electronic whiteboard on a network; and
a terminal apparatus for entering an input to the electronic whiteboard, wherein
the terminal apparatus comprises: an object display unit that sets, at an indicated place in the electronic whiteboard displayed in a screen, a drawing area in which objects that include text and graphics are permitted to be drawn; an input operation identification unit that identifies content of an input operation performed on the electronic whiteboard; and an input operation estimation unit that estimates a command intended by the input operation, based on identified content of the input operation and a relation between a location in the screen at which the input operation has been performed and a location of the drawing area.

7. An input assist method for an electronic whiteboard comprising:
setting, by a computer, at an indicated place in the electronic whiteboard displayed in a screen, a drawing area in which objects that include text and graphics are permitted to be drawn, identifying content of an input operation performed on the electronic whiteboard, and estimating a command intended by the input operation, based on identified content of the input operation and a relation between a location in the screen at which the input operation has been performed and a location of the drawing area.

8. A non-transitory computer-readable recording medium storing
a program that causes a computer to execute processes of setting, at an indicated place in the electronic whiteboard displayed in a screen, a drawing area in which objects that include text and graphics are permitted to be drawn, identifying content of an input operation performed on the electronic whiteboard, and estimating a command intended by the input operation, based on identified content of the input operation and a relation between a location in the screen at which the input operation has been performed and a location of the drawing area.
